(19) United States
(12) Patent Application Publication
(10) Pub. No.: US 2026/0328710 A1
(43) Pub. Date: Oct. 22, 2026

(54) SYSTEMS AND METHODS FOR WAFER INSPECTION AND SEGMENTED TOTAGRAPHY

(71) Applicant: WAVEFRONT ANALYSIS SYSTEMS LLC, NEW YORK, NY (US)

(72) Inventor: Okan Ersoy, West Lafayette, IN (US)

(21) Appl. No.: 19/114,136

(22) PCT Filed: Sep. 22, 2023
(86) PCT No.: PCT/US2023/074920

§ 371 Date: Mar. 21, 2025

Related U.S. Application Data
(60) Provisional application No. 63/376,680, filed on Sep. 22, 2022.
(60) Provisional application No. 63/483,067, filed on Feb. 3, 2023.

(51) Int. Cl. G01N 23/18; G01N 23/083

(52) U.S. Cl. CPC G01N 23/18; G01N 23/083; G01N 2223/304; G01N 2223/6116

(57) ABSTRACT

Aspects of the present invention relate to a method of inspecting a wafer having the steps of exposing a first portion of a wafer to a radiative source to produce an input signal, passing the input signal through at least a first mask to collect a first masked input, passing the input signal through at least a second mask to collect a second masked input, measuring the amplitudes for the Fourier transforms of the masked inputs via a sensor configured to detect emissions of the radiative source, assigning a set of random phase values to the amplitudes of the Fourier transforms of the masked inputs to produce a set of measured inputs, calculating the inverse Fourier transform of the measured inputs, averaging the inverse Fourier transformed inputs to produce a candidate output, determining whether the candidate output has converged, repeating the method beginning with the passing step including passing through at least a first and second masks, providing the candidate output as the input signal, until the candidate output converges, and providing the candidate output as an output of the system.

### CROSS-REFERENCE TO RELATED APPLICATIONS

This application claims priority to U.S. Provisional Patent Application No. 63/376,680, filed Sep. 22, 2022, and U.S. Provisional Patent Application No. 63/483,067, filed Feb. 3, 2023, both of which are incorporated herein by reference in their entirety.

### BACKGROUND OF THE INVENTION

(Coherent) totagraphy is a new approach for recovering phase of coherent waves in which several measurements are generated by using special masks in an imaging system with inputs and outputs. The common theme is the use of one transparent mask and a minimum number of additional binary masks, measurement of several intensity images, and subsequent iterative optimization by Gerchberg's second method to recover phase. The present disclosure focuses on ultraviolet and X-ray wavelengths. Among ultraviolet waves, extreme ultraviolet (EUV) is of particular interest in certain embodiments.

A major advantage of totagraphy is that the recording system is based on intensity (amplitude) recording only since phase is recovered. Even at wavelengths at which direct phase recording is possible, direct phase recording usually involves advanced, complex electronics which is very costly. By measuring only amplitude, the imaging system can be made much simpler with low cost. At EUV and X-ray wavelengths, this approach is especially called for since direct recording of phase is very difficult.

Information embedded in terms of amplitude and phase as in coherent wave representations leads to applications which are 1 or higher dimensional as in imaging. In such systems, phase is often more important than amplitude. In many coherent systems, phase is lost because what is measurable is intensity which is proportional to the square of the amplitude. Phase might also be intentionally lost. Phase recovery is also important with one-dimensional signals in a number of applications such as speech recognition, blind channel estimation, and blind deconvolution. The phase problem goes back to Rayleigh who wrote about it in 1892. Phase recovery has been a celebrated problem in succeeding years, and this process has accelerated after the 1960's when the laser and other important sources of coherent radiation were discovered.

There are indirect ways to recover phase and thereby achieve complete information recovery, for example, in diffractive imaging resulting in 3-D information. Holography discovered by Dennis Gabor is one of them, and it achieves 3-D imaging by introducing a reference wave. This has a lot to do with modulation principles used in communications. Another way is closely related to the Gerchberg-Saxton algorithm (1971-72), also known as the original Gerchberg-Saxton algorithm, and referred to as “GSA” herein, which involves measurements on two related planes, the input plane and the output spectral plane. Advances in a number of areas in science and technology are related to the GSA published in 1972 [R. W. Gerchberg, W. O. Saxton, “A practical algorithm for the determination of the phase from image and diffraction plane pictures,” Optik, Vol. 35, pp. 237-246, 1972].

R. W. Gerchberg later made an improvement to the GSA by introducing N independent measurement systems on two planes especially by using phase masks. This improvement is known herein as “Gerchberg's second method,” or “G2.” G2 was published in R. W. Gerchberg, “A New Approach to Phase Retrieval of a Wave Front,” Journal of Modern Optics, 49:7, 1185-1196, 2002, incorporated by reference in its entirety herein. Further aspects of G2 are described in U.S. Pat. Nos. 6,369,932 B1; 6,545,790; and 8,040,595 all incorporated by reference in their entirety herein.

Unlike holography, G2 does not necessarily require a reference wave. Rather, G2 is similar to measuring a quantity of interest in N independent ways and then doing averaging between the results. The patents show how to achieve this in practice when using waves. G2 is believed to be the first such method using multiple measurements for reliable phase recovery. Some other well-known methods for phase recovery are the error reduction (ER) algorithm [J, R, Fienup, ‘Reconstruction of an object from its Fourier transform,’ Optics Letters, Vol. 3, No 1, pp. 27-29, July 1978; J. R. Fienup, ‘Phase retrieval algorithms, a comparison,’ Applied Optics, Vol. 21, No. 15, pp. 2758-2769, 1 Aug., 1982], the averaged successive relaxations (ASR) [J. C. H. Spence, ‘Diffractive (lensless) imaging,’ Ch. 19, Science of Microscopy, edited by P. W. Hawkes, J. C. H. Spence, Springer, 2007], the hybrid projection reflections (HPR) [H. H. Bauschke, P. L. Combettes, D. Russell Luke, ‘Hybrid projection-reflection method for phase retrieval,’ J. Optical Soc. Am. A, Vol. 20, No. 6, pp. 1025-134 Jun. 2003], relaxed averaged alternating reflections (RAAR) [D. Russell Luke, ‘Relaxed averaged alternating reflections for diffraction imaging,’ Inverse Problems, Vol. 21, pp. 37-50, 2005], oversampling smoothness (OSS) [J. A. Rodriguez, R. Xu, C.-C. Chen, Y. Zou, and J. Miao, ‘Oversampling smoothness: an effective algorithm for phase retrieval of noisy diffraction intensities,‘ J. Applied Crystallography, Vol. 46, pp. 312-318, 2013] and difference maps (DM) [V. Elser, ‘Solution of the crystallographic phase problem by iterated projections,’ Acta Crystallography. Section A: Foundations Crystallography, Vol. 59, pp. 201-209, 2003]. There are a number of algorithms considerably more recent, utilizing more effective optimization methods such as SO2D and SO4D [Stefano Marchesini, ‘Phase retrieval and saddle-point optimization,’ J. Optical Soc. Am. A, Vol. 24, No. 10, pp. 3289-3296 Oct. 2007]. A new benchmark study of many popular phase retrieval algorithms is discussed in PhasePack [R. Chandra, T. Goldstein, C. Studer, ‘Phasepack: a phase retrieval library,‘ IEEE 13^{th} international conference on sampling theory and applications, pp. 1-5, 2019]. In this work, averaging and masking with 8 bipolar binary masks at the system input is used with 12 iterative phase recovery methods in the same way as in G2.

The common theme in all these algorithms is to achieve best phase recovery by using prior information and constraints. Use of input masks leads to such prior information. Nonnegativity, support information, and amplitude information are also commonly used as prior information. Support information is especially important. This often means the (complex) image of size N×N is at the center of a window surrounded by zeros to make the total size 2N×2N. This is also important when using the fast Fourier transform (FFT) to approximate the continuous Fourier transform in digital implementations.

Experimental work indicates that there is usually not enough prior information with a single measurement of amplitudes in the Fourier domain for perfect phase and image recovery. In other words, the recovery results with given data may be better with some methods than others, but the recovery is usually not perfect, namely it is often approximate without additional information. Works involving multiple measurements by using input masks outlined above make up for this deficiency.

Recently, machine learning, and especially deep learning methods have been utilized, often for improving the results obtained with previous phase recovery methods. For example, two deep neural networks (DNNs) have been used together with the HIO method to improve the phase recovery results [ç. Işil, F. S. Oktem, and A. Koç, ‘Deep iterative reconstruction for phase retrieval,’ Applied Optics, Vol. 58, pp. 5422-5431, 2019].

First, a DNN is used iteratively with the HIO method to improve the reconstructions. Next, a second DNN is trained to remove the remaining artifacts.

There is a growing realization in the research community that multiple measurements are necessary if high quality phase and image recovery are required. Quite recently, a number of such methods have been published in the literature. Below a discussion is presented on some methods having multiple measurements with some similarity to Gerchberg's G2 method.

In the phaselift method by Candes et al. [E. J. Candes, Y. Eldar, T. Strohmer, V, Voroninski, ‘Phase Retrieval via Matrix Completion,’ preprint, August 2011; E. J. Candes, X. Li, M. Soltanolkotabi, ‘Phase Retrieval from Coded Diffraction Patterns,’ Stanford University, Technical Report No. 2013-12, December 2013] the initial approach is the same as in Gerchberg's G2 method. In other words, a number of measurements are taken by using a number of masks. They also mention the use of optical grating, ptychography and oblique illuminations as substitutes for masks. However, masks are the major mechanism used in their papers. The averaging step in G2 is replaced by a convex optimization method, which is also related to the matrix completion or matrix recovery problems.

In the Fourier-weighted projections method by Sicairos and Fienup [M. Guizar-Sicairos, J. R. Fienup, ‘Phase Retrieval with Fourier-Weighted Projections,’ J. Optical Soc. Am. A, Vol. 25, No. 3, pp. 701-709, March 2008], masks are also used to achieve high quality phase recovery. They propose different types of masks for this purpose.

Ptychography is another method which utilizes multiple diffraction intensity measurements [J. M. Rodenburg, ‘Ptychography and Related Imaging Methods,’ Advances in Imaging and Electron Physics, Vol. 150, pp. 87-184, 2008]. It was first introduced by Hoppe in the time period 1968-1973, especially for X-ray imaging. Ptychography relies on recording at least 2 diffraction intensities by shifting the illumination function or the aperture function with respect to the object to be imaged by a known amount instead of relying on masks. Thus, there is a moving probe which illuminates the object at a time. When there is sufficient amount of overlap between the different parts of illumination, phase recovery can be achieved by an iterative phase retrieval algorithm. Another related algorithm has recently been developed by Sicairos and Fienup based on diverse far field intensity measurements taken after translating the object relative to the known illumination pattern [M. Guizar-Sicairos, J. R. Fienup, ‘Phase Retrieval with Transverse Translation Diversity: A Nonlinear Optimization Approach,’ Optics Express, Vol. 16, No. 10, pp. 7264-7278, 12 May, 2008]. In this work, nonlinear optimization is used.

In summary, multiple diffraction intensity measurements are currently in use in the research community to solve phase and image recovery problems, for example, leading to diffractive (lensless) imaging [B. Abbey et al, ‘Lensless Imaging Using Broadband X-Ray Sources,’ Nature Photonics, pp. 420-424, 26 Jun. 2011]. This is especially important in areas such as X-ray and far infrared imaging in which lenses are very expensive.

In a number of applications such as wafer chip inspection, the object area to be imaged can be very large. The sensor to be used such as a CCD camera cannot handle larger object areas. The amount of computation as well as storage would also be excessive. Thus, in certain embodiments it is necessary to segment the object area, and to apply totagraphy to each segment. This is especially important with EUV and X-ray waves with extremely small wavelengths.

### SUMMARY OF THE INVENTION

Aspects of the present invention relate to a method of inspecting a wafer having the steps of exposing a first portion of a wafer to a radiative source to produce an input signal, passing the input signal through at least a first mask to collect a first masked input, passing the input signal through at least a second mask to collect a second masked input, measuring the amplitudes for in the Fourier transforms of the masked inputs via a sensor configured to detect emissions of the radiative source, assigning a set of random phase values to the amplitudes of the Fourier transforms of the masked inputs to produce a set of measured inputs, calculating the inverse Fourier transform of the measured inputs, averaging the inverse Fourier transformed inputs to produce a candidate output, determining whether the candidate output has converged, repeating the method beginning with the passing step including passing through at least a first and second masks, providing the candidate output as the input signal, until the candidate output converges, and providing the candidate output as an output of the system.

In some embodiments, the method further has the steps of moving at least one of the sensor, the radiative source, and the mask relative to the wafer and repeating the method for a second portion of the wafer different from the first portion of the wafer while the other portions are made electronically inactive, to generate a set of converged partial candidate outputs, combining the set of converged partial candidate outputs to form a unified candidate output, and providing the unified candidate output as the output of the system.

In some embodiments, the method further has the steps of using an array of sensors, an array of masks, and illuminating one portion of the wafer at each time with corresponding mask and sensor, and repeating the method for a second portion of the wafer different from the first portion of the wafer while the other portions are made electronically inactive, and continuing this process with all the portions, combining the converged candidate outputs of all the portions of the wafer to form a unified candidate output, and providing the unified candidate output as an output of the system.

In some embodiments, the first mask is a transparent mask, and the second mask includes a pair of complimentary unipolar binary masks. In some embodiments, the at least first and second masks include an outer border having a thickness. In some embodiments, the masks are physical spatial masks and the method further has the step of switching from one of the physical spatial masks to another of the physical spatial masks.

In some embodiments, the step of passing the input signal through the at least first and second masks includes the step of splitting the input signal so that it is individually received in parallel by the at least first and second masks. In some embodiments, the radiative source is selected from X-Rays or ultraviolet (UV) light.

Aspects of the present invention relate to a method of recovering phase information from an input signal having the steps of exposing a measurement surface to a coherent radiative source, the radiative source selected from ultraviolet (UV) light or X-Rays to produce an input signal, passing the input signal through at least first and second masks to collect first and second masked inputs, wherein the first mask is a transparent mask, measuring the amplitudes of the Fourier transforms of the masked inputs via a sensor configured to detect emissions of the radiative source, assigning a set of random phase values to the amplitudes of the Fourier transforms of the masked inputs to produce a set of measured inputs, calculating the inverse Fourier transforms of the measured inputs, averaging the inverse Fourier transformed inputs to produce a candidate output, determining whether the candidate output has converged, repeating the method digitally, beginning with the passing step comprising passing through at least first and second masks, providing the candidate output as the input signal, until the candidate output converges, and providing the converged candidate output as an output of the system.

In some embodiments, the first mask is a transparent mask, and the second mask includes a pair of complimentary unipolar binary masks. In some embodiments, each of the at least first and second masks includes an outer border having a thickness. In some embodiments, the masks are physical spatial masks and the method further has the step of switching from one of the physical spatial masks to another of the physical spatial masks. In some embodiments, the step of passing the input signal through the at least first and second masks includes the step of splitting the input signal so that it is individually received in parallel by the at least first and second masks.

### BRIEF DESCRIPTION OF THE DRAWINGS

The foregoing purposes and features, as well as other purposes and features, will become apparent with reference to the description and accompanying figures below, which are included to provide an understanding of the invention and constitute a part of the specification, in which like numerals represent like elements, and in which:

FIG. 1 is an exemplary computing device.

FIG. 2 is a diagram of an exemplary totagraphic system using a reference wave.

FIG. 3A, FIG. 3B, FIG. 3C, FIG. 3D and FIG. 3E are diagrams of different configurations for an imaging/inspection device.

FIG. 4 is a diagram of an X-ray based wafer inspection device.

FIG. 5A is a diagram of an optical sensing unit.

FIG. 5B is a diagram of a digital sensing unit.

FIG. 5C and FIG. 5D are diagrams of initial and subsequent iterations of an image processing method.

FIG. 6 is a diagram of a lens-less imaging configuration.

FIG. 7 is a set of original and recovered images and a graph of convergence.

FIG. 8 is a set of original and recovered images and a graph of convergence.

FIG. 9A and FIG. 9B are of original amplitude and phase images.

FIG. 9C and FIG. 9D are original and reconstructed amplitude patch images.

FIG. 9E is a graph of convergence.

FIG. 10A and FIG. 10B are original and reconstructed phase patch images.

FIG. 10C is a graph of convergence.

FIG. 11A and FIG. 11B are reconstructed amplitude and phase images.

FIG. 12A and FIG. 12B are of original amplitude and phase images.

FIG. 13A and FIG. 13B are original and reconstructed amplitude patch images.

FIG. 13C is a graph of convergence.

FIG. 14A and FIG. 14B are original and reconstructed phase patch images.

FIG. 14C is a graph of convergence.

FIG. 15A and FIG. 15B are reconstructed amplitude and phase images.

FIG. 16 is a set of original and recovered images and a graph of convergence and shows Xray reconstructed images and error reduction when the reference wave amplitude is 25000, and the maximum number of iterations is 5.

FIG. 17 is a set of original and recovered images and a graph of convergence and shows the Xray reconstructed images and error reduction when the reference wave amplitude is 25000, and the maximum number of iterations is 10.

FIG. 18 is a set of original and recovered images and a graph of convergence and shows the Xray reconstructed images and error reduction when the reference wave amplitude is 25000, and the maximum number of iterations is 15.

FIG. 19 is a set of original and recovered images and a graph of convergence and shows Xray reconstructed images and error reduction when the reference wave amplitude is 25000, and the maximum number of iterations is 20.

FIG. 20 is a set of original and recovered images and a graph of convergence and shows Xray reconstructed images and error reduction when the reference wave amplitude is 25000, and the maximum number of iterations is 25.

FIG. 21 is a set of original and recovered images and a graph of convergence and shows Xray reconstructed images and error reduction with no reference wave and when the maximum number of iterations is 50.

FIG. 22 is a set of original and recovered images and a graph of convergence and shows Xray reconstructed images and error reduction when the reference wave amplitude equals 5000, and the maximum number of iterations is 50.

FIG. 23 is a set of original and recovered images and a graph of convergence and shows Xray reconstructed images and error reduction when the reference wave amplitude equals 10000, and the maximum number of iterations is 50.

FIG. 24 is a set of original and recovered images and a graph of convergence and shows Xray reconstructed images and error reduction when the reference wave amplitude equals 15000, and the maximum number of iterations is 50.

FIG. 25 is a set of original and recovered images and a graph of convergence and shows Xray reconstructed images and error reduction when the reference wave amplitude equals 20000, and the maximum number of iterations is 50.

FIG. 26 is a set of original and recovered images and a graph of convergence and shows Xray reconstructed images and error reduction when the reference wave amplitude equals 25000, and the maximum number of iterations is 50.

FIG. 27 is a set of original and recovered images and a graph of convergence and shows Xray reconstructed images and error reduction when the reference wave amplitude equals 1000000, and the maximum number of iterations is 10.

FIG. 28 is a set of original and recovered images and a graph of convergence and shows Xray reconstructed images and error reduction when the reference wave amplitude equals 1000000, and the maximum number of iterations is 20.

FIG. 29 is a set of original and recovered images and a graph of convergence and shows Xray reconstructed images and error reduction when the reference wave amplitude equals 1000000, and the maximum number of iterations is 30.

FIG. 30 is a set of original and recovered images and a graph of convergence and shows Xray reconstructed images and error reduction when the reference wave amplitude equals 1000000, and the maximum number of iterations is 40.

FIG. 31 is a set of original and recovered images and a graph of convergence and shows Xray reconstructed images and error reduction when the reference wave amplitude equals 1000000, and the maximum number of iterations is 50.

FIG. 32 is a set of original and recovered images and a graph of convergence and shows EUV reconstructed images and error reduction when the reference wave amplitude is 25000, and the maximum number of iterations is 5.

FIG. 33 is a set of original and recovered images and a graph of convergence and shows EUV reconstructed images and error reduction when the reference wave amplitude is 25000, and the maximum number of iterations is 10.

FIG. 34 is a set of original and recovered images and a graph of convergence and shows EUV reconstructed images error reduction when the maximum number of iterations is 15.

FIG. 35 is a set of original and recovered images and a graph of convergence and shows EUV reconstructed images error reduction when the maximum number of iterations is 20.

FIG. 36 is a set of original and recovered images and a graph of convergence and shows EUV reconstructed images error reduction when the maximum number of iterations is 25.

FIG. 37 is a set of original and recovered images and a graph of convergence and shows EUV reconstructed images error reduction with no reference wave and when the maximum number of iterations is 50.

FIG. 38 is a set of original and recovered images and a graph of convergence and shows EUV reconstructed images and error reduction when the reference wave amplitude equals 5000, and the maximum number of iterations is 50.

FIG. 39 is a set of original and recovered images and a graph of convergence and shows EUV reconstructed images error reduction when the reference wave amplitude equals 10000, and the maximum number of iterations is 50.

FIG. 40 is a set of original and recovered images and a graph of convergence and shows EUV reconstructed images error reduction when the reference wave amplitude equals 15000, and the maximum number of iterations is 50.

FIG. 41 is a set of original and recovered images and a graph of convergence and shows EUV reconstructed images error reduction when the reference wave amplitude equals 20000, and the maximum number of iterations is 50.

FIG. 42 is a set of original and recovered images and a graph of convergence and shows EUV reconstructed images error reduction when the reference wave amplitude equals 25000, and the maximum number of iterations is 50.

FIG. 43 is a set of original and recovered images and a graph of convergence and shows the reconstructed images and error reduction when the reference wave amplitude equals 1000000, and the maximum number of iterations is 10.

FIG. 44 is a set of original and recovered images and a graph of convergence and shows reconstructed images and error reduction when the reference wave amplitude equals 1000000, and the maximum number of iterations is 20.

FIG. 45 is a set of original and recovered images and a graph of convergence and shows the reconstructed images and error reduction when the reference wave amplitude equals 1000000, and the maximum number of iterations is 30.

FIG. 46 is a set of original and recovered images and a graph of convergence and shows the reconstructed images and error reduction when the reference wave amplitude equals 1000000, and the maximum number of iterations is 40.

FIG. 47 is a set of original and recovered images and a graph of convergence and shows the reconstructed images and error reduction when the reference wave amplitude equals 1000000, and the maximum number of iterations is 50.

### DETAILED DESCRIPTION

It is to be understood that the figures and descriptions of the present invention have been simplified to illustrate elements that are relevant for a clear understanding of the present invention, while eliminating, for the purpose of clarity, many other elements found in related systems and methods. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, exemplary methods and materials are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20%, ±10%, ±5%, ±1%, and ±0.1% from the specified value, as such variations are appropriate.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, 6 and any whole and partial increments therebetween. This applies regardless of the breadth of the range.

In some aspects of the present invention, software executing the instructions provided herein may be stored on a non-transitory computer-readable medium, wherein the software performs some or all of the steps of the present invention when executed on a processor.

Aspects of the invention relate to algorithms executed in computer software. Though certain embodiments may be described as written in particular programming languages, or executed on particular operating systems or computing platforms, it is understood that the system and method of the present invention is not limited to any particular computing language, platform, or combination thereof. Software executing the algorithms described herein may be written in any programming language known in the art, compiled or interpreted, including but not limited to C, C++, C#, Objective-C, Java, JavaScript, MATLAB, Python, PHP, Perl, Ruby, or Visual Basic. It is further understood that elements of the present invention may be executed on any acceptable computing platform, including but not limited to a server, a cloud instance, a workstation, a thin client, a mobile device, an embedded microcontroller, a television, or any other suitable computing device known in the art.

Parts of this invention are described as software running on a computing device. Though software described herein may be disclosed as operating on one particular computing device (e.g. a dedicated server or a workstation), it is understood in the art that software is intrinsically portable and that most software running on a dedicated server may also be run, for the purposes of the present invention, on any of a wide range of devices including desktop or mobile devices, laptops, tablets, smartphones, watches, wearable electronics or other wireless digital/cellular phones, televisions, cloud instances, embedded microcontrollers, thin client devices, or any other suitable computing device known in the art.

Similarly, parts of this invention are described as communicating over a variety of wireless or wired computer networks. For the purposes of this invention, the words “network”, “networked”, and “networking” are understood to encompass wired Ethernet, fiber optic connections, wireless connections including any of the various 802.11 standards, cellular WAN infrastructures such as 3G, 4G/LTE, or 5G networks, Bluetooth®, Bluetooth® Low Energy (BLE) or Zigbee® communication links, or any other method by which one electronic device is capable of communicating with another. In some embodiments, elements of the networked portion of the invention may be implemented over a Virtual Private Network (VPN).

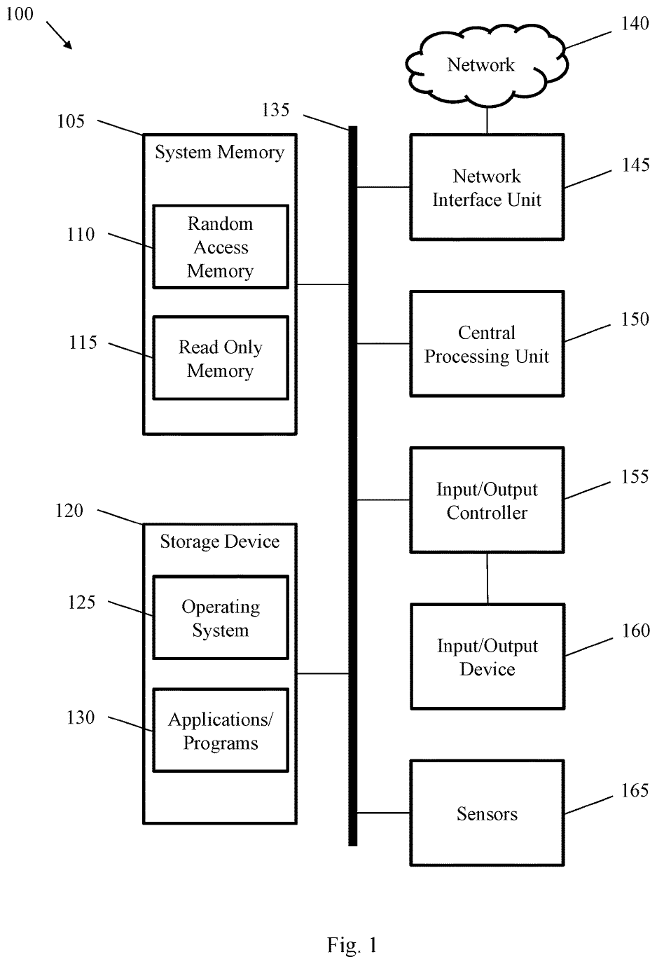

FIG. 1 and the following discussion are intended to provide a brief, general description of a suitable computing environment in which the invention may be implemented. While the invention is described above in the general context of program modules that execute in conjunction with an application program that runs on an operating system on a computer, those skilled in the art will recognize that the invention may also be implemented in combination with other program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

FIG. 1 depicts an illustrative computer architecture for a computer 100 for practicing the various embodiments of the invention. The computer architecture shown in FIG. 1 illustrates a conventional personal computer, including a central processing unit 150 (“CPU”), a system memory 105, including a random access memory 110 (“RAM”) and a read-only memory (“ROM”) 115, and a system bus 135 that couples the system memory 105 to the CPU 150. A basic input/output system containing the basic routines that help to transfer information between elements within the computer, such as during startup, is stored in the ROM 115. The computer 100 further includes a storage device 120 for storing an operating system 125, application/program 130, and data.

The storage device 120 is connected to the CPU 150 through a storage controller (not shown) connected to the bus 135. The storage device 120 and its associated computer-readable media provide non-volatile storage for the computer 100. Although the description of computer-readable media contained herein refers to a storage device, such as a hard disk or CD-ROM drive, it should be appreciated by those skilled in the art that computer-readable media can be any available media that can be accessed by the computer 100.

By way of example, and not to be limiting, computer-readable media may comprise computer storage media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

According to various embodiments of the invention, the computer 100 may operate in a networked environment using logical connections to remote computers through a network 140, such as TCP/IP network such as the Internet or an intranet. The computer 100 may connect to the network 140 through a network interface unit 145 connected to the bus 135. It should be appreciated that the network interface unit 145 may also be utilized to connect to other types of networks and remote computer systems.

The computer 100 may also include an input/output controller 155 for receiving and processing input from a number of input/output devices 160, including a keyboard, a mouse, a touchscreen, a camera, a microphone, a controller, a joystick, or other type of input device. Similarly, the input/output controller 155 may provide output to a display screen, a printer, a speaker, or other type of output device. The computer 100 can connect to the input/output device 160 via a wired connection including, but not limited to, fiber optic, Ethernet, or copper wire or wireless means including, but not limited to, Wi-Fi, Bluetooth, Near-Field Communication (NFC), infrared, or other suitable wired or wireless connections.

As mentioned briefly above, a number of program modules and data files may be stored in the storage device 120 and/or RAM 110 of the computer 100, including an operating system 125 suitable for controlling the operation of a networked computer. The storage device 120 and

RAM 110 may also store one or more applications/programs 130. In particular, the storage device 120 and RAM 110 may store an application/program 130 for providing a variety of functionalities to a user. For instance, the application/program 130 may comprise many types of programs such as a word processing application, a spreadsheet application, a desktop publishing application, a database application, a gaming application, internet browsing application, electronic mail application, messaging application, and the like. According to an embodiment of the present invention, the application/program 130 comprises a multiple functionality software application for providing word processing functionality, slide presentation functionality, spreadsheet functionality, database functionality and the like.

The computer 100 in some embodiments can include a variety of sensors 165 for monitoring the environment surrounding and the environment internal to the computer 100. These sensors 165 can include a Global Positioning System (GPS) sensor, a photosensitive sensor, a gyroscope, a magnetometer, thermometer, a proximity sensor, an accelerometer, a microphone, biometric sensor, barometer, humidity sensor, radiation sensor, or any other suitable sensor.

### X-Rays

X-rays are EM waves of extremely short wavelength and high frequency, with wavelengths ranging from about 10 to 0.001 nanometer (nm) and corresponding frequencies from about 1016 to 1020 Hz.

X-rays are commonly produced by accelerating (or decelerating) charged particles; examples include a beam of electrons striking a metal plate in an X-ray tube. X-rays can pass through materials, including biological tissue, can be recorded with photographic films and other detectors.

Defining characteristics of X-rays include their ability to penetrate optically opaque materials, wavelengths of atomic dimension, the high energy of individual X-ray photons makes them well-suited to a wide range of industrial, medical, and scientific applications.

Coherent imaging with X-rays has been developed, especially with x-ray holography (F. Buttner, et al., Holographic materials and optical systems, 2016; and T. Salditt, et al., Applied Physics, 2020).

### Ultra Violet Waves

As used herein, Ultraviolet (UV) refers to electromagnetic radiation with wavelengths from 10 nm (with a corresponding frequency around 30 PHz) to 400 nm (750 THz). UV radiation is present in sunlight, and constitutes about 10% of the total electromagnetic radiation output from the Sun.

Extreme ultraviolet radiation (EUV or XUV) or high-energy ultraviolet radiation is electromagnetic radiation spanning wavelengths from 124 nm down to 10 nm, having photons with energies from 10 eV up to 124 eV. EUV is naturally generated by the solar corona and artificially by plasma, high harmonic generation sources and synchrotron light sources.

The main uses of extreme ultraviolet radiation are photoelectron spectroscopy, solar imaging, and lithography. Currently, most advanced and high-resolution electronic chips are fabricated using EUV lithography.

Coherent imaging with EUV waves has been developed (see M. Zurch et al, Scientific Reports, 2014).

Waves are usually characterized as coherent and incoherent. Coherent waves such as laser beams have amplitude and phase expressed as a complex number at each point in space. In some aspects of this disclosure, coherent X-ray and EUV waves are considered.

Totagraphy (CT) is a method for recovering phase of coherent waves in which several measurements are generated by using special masks or structured illumination (also referred to as masks) in a hardware imaging system with inputs and outputs. More information about Totagraphy may be found in U.S. Pat. No. 11,237,059, issued on Feb. 1, 2022, incorporated herein by reference.

In some embodiments, the imaging system can be free space propagation, resulting in lensless imaging. The origins of CT can be traced to Gerchberg's second method (R. W. Gerchberg, Journal of Modern Optics, 2002; and U.S. Pat. No. 6,369,932, issued Apr. 9, 2002, both of which are incorporated herein by reference). After initial measurements with the imaging system, the remaining processing for imaging is digital and iterative. During iterations, the inputs are averaged, passed through the masks and propagated to the output where the initial known amplitude and current phase is used. After backpropagating to the input, the next round of iteration is repeated in the same way. This process continues until convergence. In some embodiments, other steps may be included to improve performance.

Totagraphy can be divided into coherent totagraphy (CT) which uses coherent waves, and incoherent totagraphy (IT) which uses incoherent waves. Coherent totagraphy has variations which use no reference wave (CT1) or which use a reference wave (TRW).

In CT, the first mask is usually a transparent mask (equivalent to no mask). The succeeding masks are usually a bipolar binary mask with elements corresponding to +1 or −1, or a pair of complimentary unipolar binary masks with elements corresponding to +1 or 0. The pair of masks is such that +1 is 0 in the other mask, and vice versa. In other words, they are complimentary to each other. In some embodiments, zero-filling is used at the boundaries of the masks corresponding to opaque regions. One bipolar binary mask or a pair of unipolar complimentary masks in addition to the transparent mask is usually sufficient for very high quality reconstruction of information.

In CT, masking in the sense of multiplying with the input image can also be achieved by using a structured illumination (pattern illumination) (Schnars et al, Springer-Verlag, 2015; and Poon, et al., Cambridge University Press, 2015.). Due to mathematical equivalence, the terms “masking” and “mask” may be used herein to refer to patterned illumination as well as to physical or programmatically-implemented masks.

Binary masks as described above exist for X-rays, and EUV waves. For example, coded aperture imaging systems use them for X-rays and EUV (M. J. Gieslak, et al, Radiation Measurements, 2016; D. S. Kittle, et al., Optical Engineering, 2012; and C. Romeo, et al., Science Direct, 2005).

Totagraphy with a reference wave (TRW) is an extension of totagraphy in which a reference wave is also used (see also U.S. patent application Ser. No. 17/545,371, filed on Dec. 8, 2021 and incorporated herein by reference). Recovery of a complex wavefield is usually more robust with TRW than with CTI with constant amplitude and zero phase. An inline plane reference wave or a spherical reference wave with constant amplitude and zero phase are used. What is referred to as camera is a device for recording the output intensity.

Coherent wave propagation can be computed with three methods, based on the distance between the input object plane and the output reconstruction plane. When this distance is very large, the Fraunhofer method can be used. For intermediate distances, the Fresnel method would be appropriate. For close distances, the angular spectrum method (ASM) is accurate. the experimental results discussed in the disclosure were obtained with the Fresnel method.

TRW is similar to digital holography. The difference is in the digital reconstruction method used. In digital holography, reconstruction involves using the reference wave illuminating the hologram. In TRW, reconstruction is based on phase recovery similar to the way it is done in CT1.

In digital holography, reconstruction of information is obtained by illumination with a reference wave. This also creates a twin image and other background noise. In order to separate the two images, it is necessary in some embodiments to use an off-axis reference wave, but this causes the desired image to be limited to a part of the output space. At some wavelengths, it may also be difficult to utilize an off-axis reference beam. It is also difficult to record a high-quality off-axis hologram because of the limitation of the narrow bandwidth of the camera used.

If an on-axis geometry is used, it is necessary to eliminate the zeroth-order light and the twin image. Among the various available techniques, phase-shifting holography (PSH) is the most widely used technique to achieve this goal. For example, a piezoelectric transducer (PZT) is used so that the optical path difference between the object light and the reference light can be adjusted. In PSH, it is usually necessary to take multiple holograms corresponding to the various phase differences between the object light and the reference light. This is usually a tedious process which requires high precision. Similarly, other techniques to eliminate the zeroth-order light and the twin image are very sensitive, especially to phase errors.

In TRW, the reference wave is eliminated at the output space during iterations for phase recovery (see also U.S. patent application Ser. No. 17/545,371, filed on Dec. 8, 2021 and incorporated herein by reference). This allows for the reconstruction of only the desired information. In the forward stage of each iteration, the reference wave is introduced since the amplitude measured at the output space always includes the reference wave. In other words, each complete iteration for phase recovery involves the inclusion of the reference wave in the forward pass and its elimination in the reverse pass of the iteration. As a consequence, the type of a reference wave appears to be not critical as long as it provides a large enough amplitude to be added to the object wave at the output for recording of intensity of the total wave. Thus, an on-axis object wave with constant amplitude and zero or constant phase works fine without drawbacks. At the conclusion of the iterations, only the amplitude and phase of the object wave are reconstructed.

With X-rays, it is more practical to implement a spherical reference wave by passing part of an X-ray through a very small hole (see S. Na et al., Journal of the Korean Physical Society, 2020). With TRW, this does not change the totagraphic iterative process.

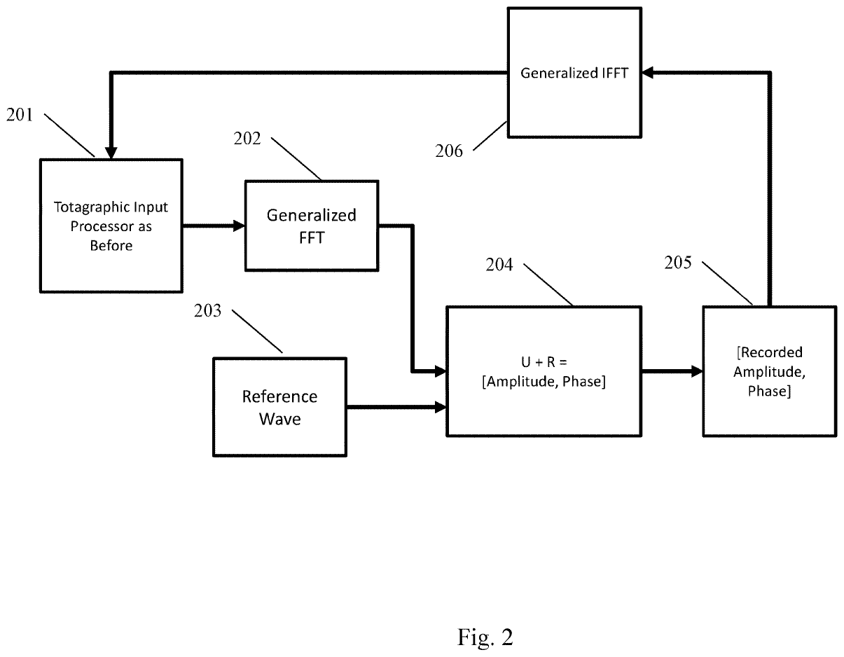

However, due to the inclusion of the reference wave, the iteration procedure for the totagraphic process is modified. FIG. 2 shows how the reference wave is added and subtracted during each iteration. With reference to FIG. 2, a totagraphic input processor 201 first obtains the input image, which is then passed through a generalized FFT 202 to produce a spectral domain amplitude image and phase image. This wave is summed with the reference wave to produce a new wave whose amplitude is recorded and kept, and its phase is discarded and replaced by a random phase image in the first iteration.

In succeeding iterations, the procedure is the same, but the spectral domain amplitude is replaced by the amplitude in the first iteration while keeping the phase, giving wave1, the reference wave is subtracted from wave1, resulting in wave2, which is fed back to the input 201 after an inverse Fourier transform 206.

Totagraphy with a reference wave (TRW) is an extension of totagraphy in which a reference wave is also used. In embodiments with X-ray and EUV waves, TRW with a strong inline plane or spherical reference wave, a transparent mask and several bipolar binary masks worked well. Hence, the experiments reported in this disclosure also use such a design.

### Segmented Totagraphy

In many applications, the object area or volume to be studied can be very large. For example, in semiconductor chip inspection, the wafer surface area typically has dimensions on the order of 300 mm on a side or in diameter. This would be prohibitive in terms of experimentation and computations when using X-ray and EUV waves. In order to ease this problem, in some embodiments, the area of interest is segmented into a number of patches, and each patch is then processed by totagraphy independently of the other patches. In this way, measurement inaccuracy between patches will be insignificant. In other words, in some embodiments, each patch is completely accurate within itself, but there may be inaccuracies between patches. In some embodiments, by making the patches independent of each other, these inaccuracies are not allowed to interfere with the reconstruction process. This also means, that in some embodiments, the patches can overlap with each other. In some embodiments, the totagraphic setup is configured to handle one patch at a time, while the other patches are made inaccessible.

This can be achieved in several ways. For example, one can start with the top left patch, move to the adjacent right patch, and so on until reaching the right side of the total area. Then, the next row of patches may start, either moving right to left or by resetting the imager to the left side patch immediately below the first patch. This process continues until all the patches are completed.

In some experiments, it may be unnecessary to complete all the patches. For example, in chip inspection, the application may be deciding whether a chip or wafer of chips is good or bad, namely, a 2-class problem. If one patch on a wafer is found to be bad, for example, and if this means that some or all chips on the wafer are bad, it may in some embodiments be unnecessary to process the remaining patches. In such a case, it may be advantageous to choose patches randomly after each other so that most of the total area is visited as quickly as possible.

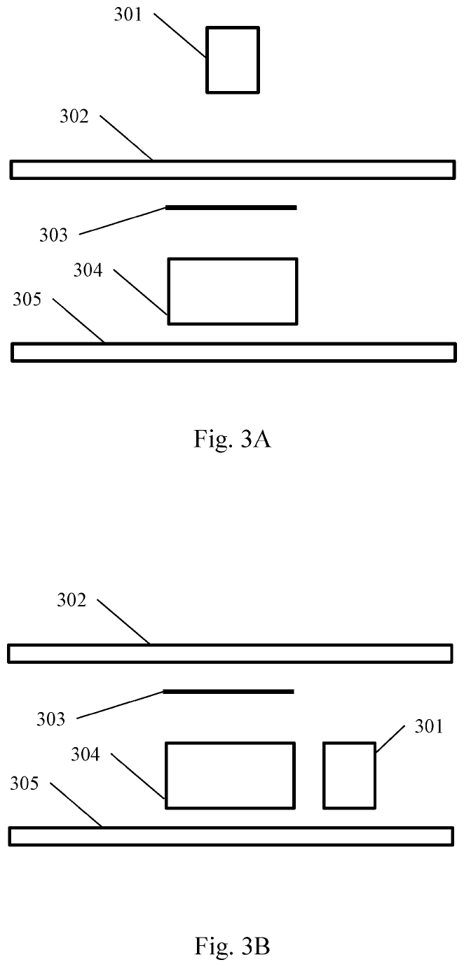

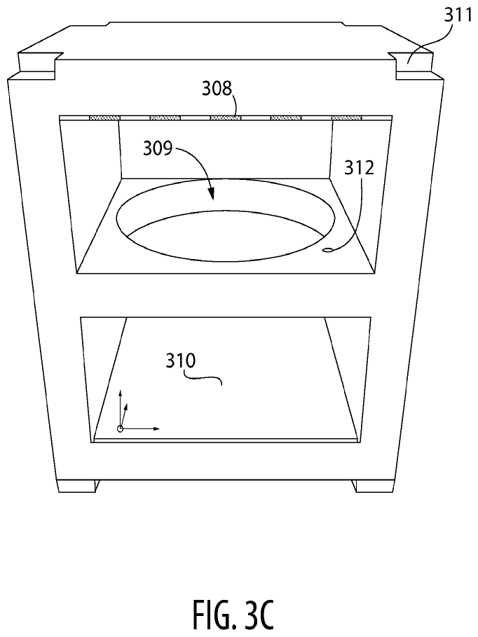

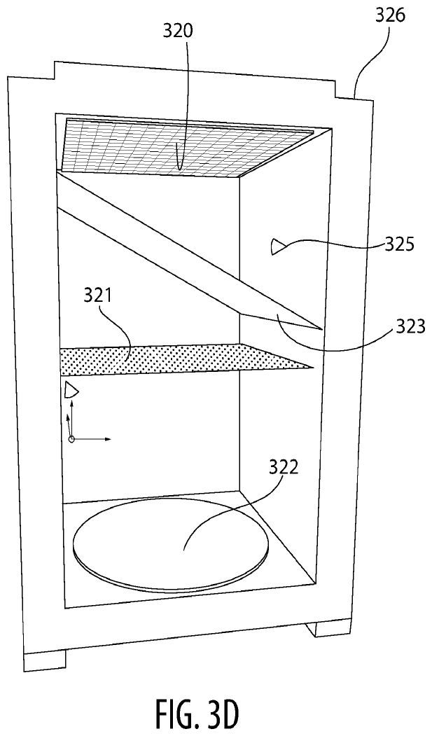

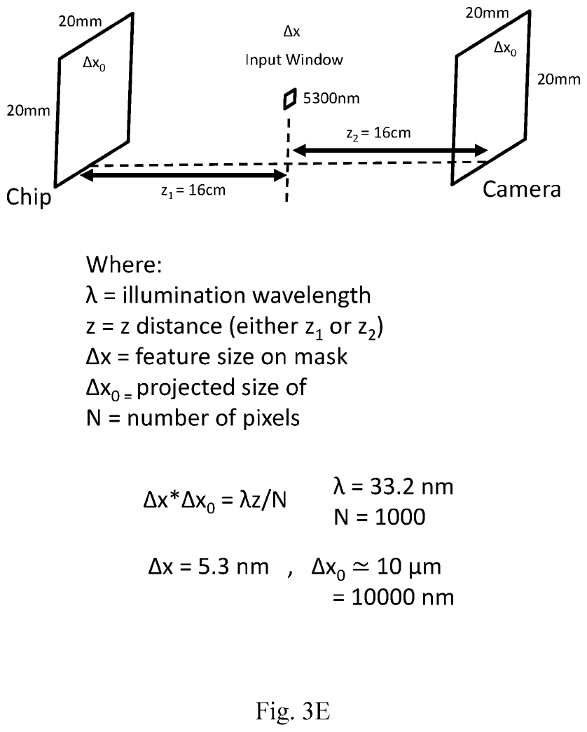

Potential physical layouts for performing segmented methods disclosed herein are shown in FIG. 3A through FIG. 3E. In a first embodiment shown in FIG. 3A, a radiative emitter 301 may be placed above a wafer 302, configured to radiate through the wafer 302 toward a sensor 304, passing through at least one physical mask 303. The sensor 304, the at least one mask 303, the wafer 302, and/or the emitter 301 may be fixedly attached to a translation surface 305 so that the sensor 304 and mask 303 (and potentially the emitter 301) can move relative to the wafer and gather images of the different segments. In some embodiments the radiative emitter 301 may for example be an X-Ray emitter, a UV emitter, an EUV emitter, and a terawave emitter.

A second potential physical layout is shown in FIG. 3B. The layout of FIG. 3B is identical to FIG. 3A, except that the radiative emitter 301 is positioned on the same side of the wafer 302 as the sensor 304. The layout of FIG. 3B may be useful for example when measuring light reflected off a surface of the wafer 302, whereas the layout of FIG. 3B may be useful for example when measuring light passed through the wafer 302.

A third potential physical layout is shown in FIG. 3C. In the embodiment shown in FIG. 3C, a sensor array 308 may be placed above an object hole containing the object 309 and a coherent plane/spherical wave source 310. The sensor array 308, object hole 309 and coherent plane/spherical wave source 310 may be fixedly attached and further comprise at least one stacking slot 311. In some embodiments, the layout further comprises a reference hole 312. In some embodiments, the layout in FIG. 3C may further comprise a housing wherein sensor array 308, object hole 309, coherent plane/spherical wave source 310, and reference hole 312 reside within the housing and stacking slot 311 resides on an outside surface of the housing for fixedly attaching to a plurality of other housings.

A fourth potential physical layout is shown in FIG. 3D. In the embodiment shown in FIG. 3D, a sensor array 320 may be placed above a mask array 321 and an object/wafer surface 322. The sensor array 320, mask array 321 and object/wafer surface 322 may be fixedly attached and further comprise a beam splitter 323, an illumination beam 324, a reference beam 325, and at least one stacking slot 326. In some embodiments, the layout in FIG. 3D may further comprise a housing wherein sensor array 320, mask array 321, object/wafer surface 322, beam splitter 323, illumination beam 324, reference beam 325 reside within the housing and stacking slot 326 resides on an outside surface of the housing for fixedly attaching to a plurality of other housings. In some embodiments, beam splitter 323 and reference beam 325 may translate on at least one axis between mask array 321 and sensor array 320.

The layouts of FIG. 3A through FIG. 3D may further comprise the features and dimensions of a layout for a single illuminated patch as described in FIG. 3E. In some embodiments, the relationship of the system is described as the following equation concerning sampling intervals (pixel sizes):

$$Δ x * Δ {x}_{0} = \frac{λ z}{N} \qquad Equation 1$$

having illumination wavelength (λ), z distance (z), feature size on mask (Δx), projected size of pixel area (Δx₀), and number of pixels (N).

In some embodiments, z₁=z₂=z=16 cm, λ=33.2 nm, and N=1000, Δx=5.3 nm, and Δx₀ is 10 μm, or 10000 nm.

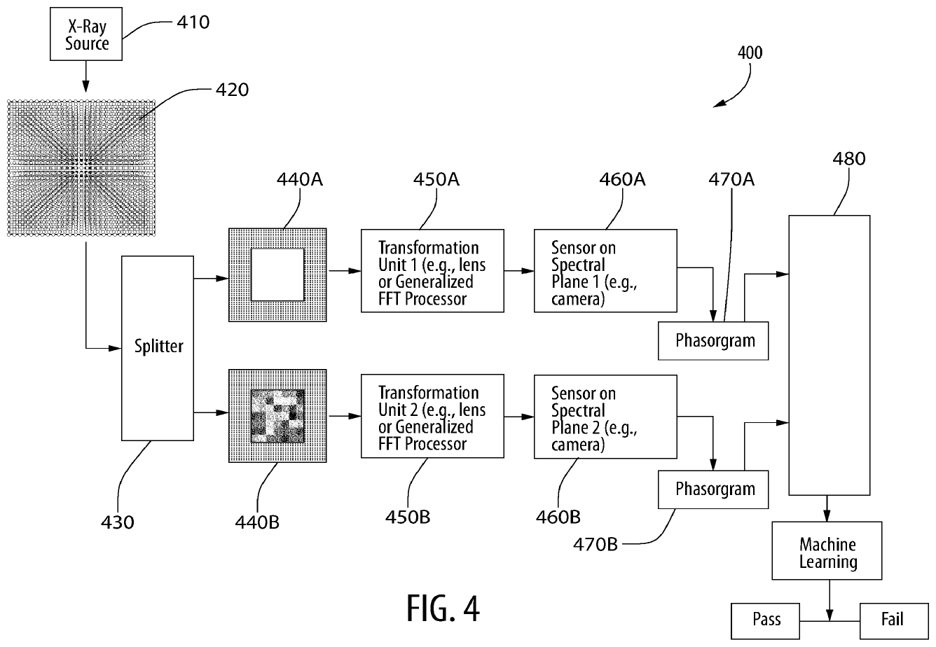

An overall system diagram of a wafer inspection system utilizing the methods disclosed herein is shown in FIG. 4 according to aspects of the present invention. The depicted exemplary wafer inspection system 400 comprises an X-ray source 410 configured to radiate X-rays through at least a portion of a wafer 420. The intensity values are then passed through a splitter 430, and then masked with a transparent mask 440A and also with one or more other masks 440A, for example a bipolar binary mask, or a pair of complimentary unipolar binary masks. In some embodiments, all masks have an opaque border. The masked inputs are then transformed with a FFT to produce a first Transformation Unit 450A and second Transformation Unit 450B, respectively, transformed either by a physical Fourier transform (e.g. a specialized lens) in the first iteration and a digital FFT in subsequent iterations, or any combination thereof. In some embodiments, Transformation Unit 450A and/or Transformation Unit 450B comprise a Generalized FFT processor. The transformed images are measured in the first iteration in sensor 460A and sensor 460B, respectively, and the transformed images (phasorgram 470A and phasorgram 470B) are passed to a totagraphic processor 480. In some embodiments, sensor 460A and/or sensor 460B comprises a sensor on a first spectral plane (e.g. first camera), and second spectral plane (e.g. second camera), respectively. In some embodiments, machine learning is then applied to the recovered image (amplitude and phase), which results in a pass/fail of all or part of the wafer. In some embodiments, Artificial intelligence (AI), deep learning, and/or machine learning are applied to the recovered images for other intelligence tasks. In some embodiments, the machine learning comprises convolutional neural networks (CNNs). In some embodiments, the neural networks require training on the images collected from the passing/failing wafers.

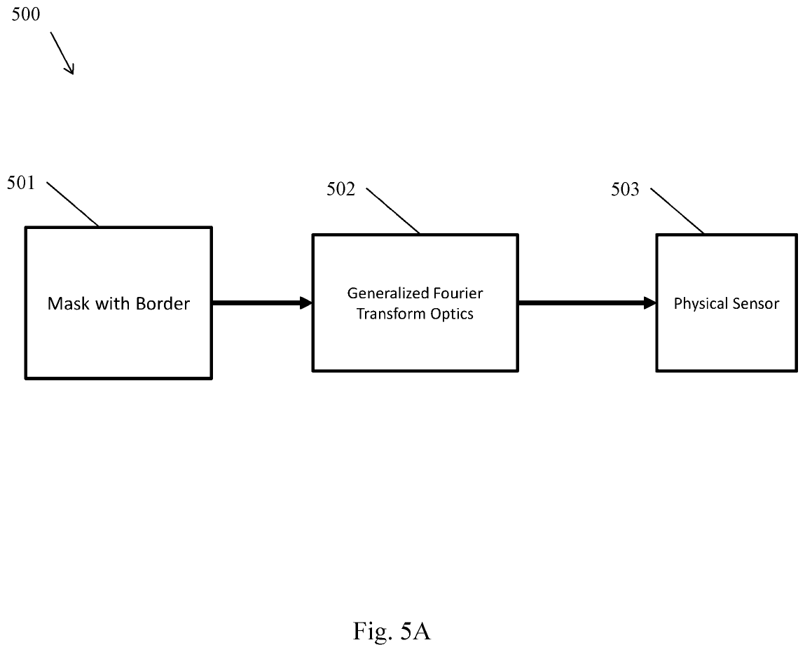

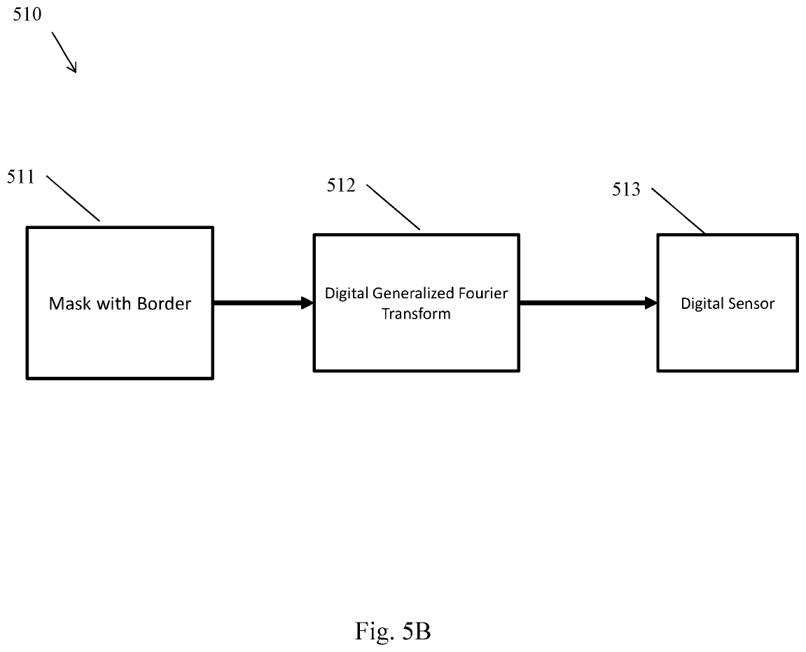

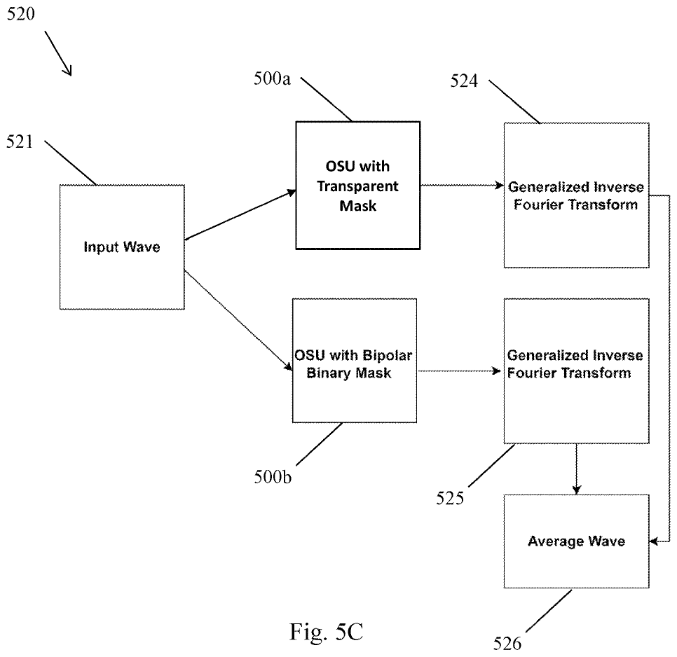

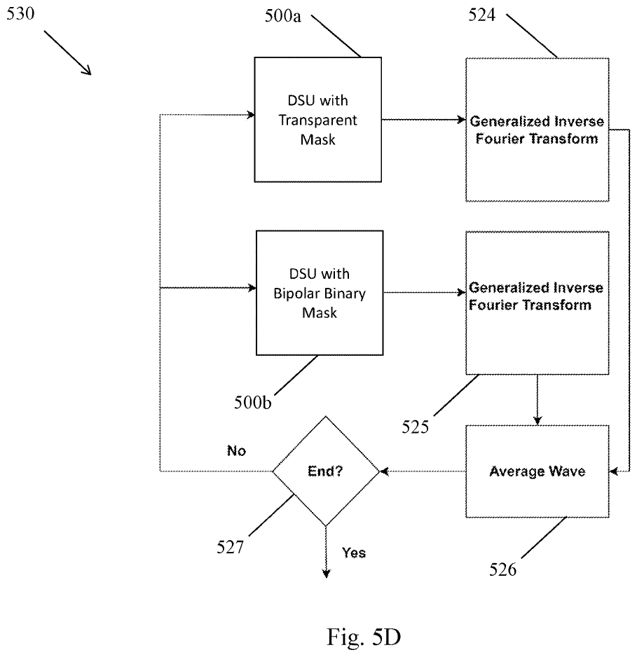

The system diagrams are shown in FIG. 5A, FIG. 5B, FIG. 5C, and FIG. 5D. FIG. 5A shows the optical sensing unit (OSU) to be used in the initial optical measurement with each mask and camera and first iteration. The OSU includes a mask with an opaque border 501, transform optics which in the disclosed embodiment are Generalized Fourier Transform optics 502, and a physical sensor 503. Although exemplary systems are depicted as having two masks, the system of the present invention may have any number of masks.

FIG. 5B shows the corresponding digital sensing unit (DSU) to be used in the succeeding iterations until convergence. Because all iterations after the initial iteration take place in digital space, the digital sensing unit includes a mask with a border 511, doubling the size of input window with the border regions of zeros, a digital transformation unit, for example the digital generalized Fourier transform 512, and a digital sensor 513. The wave fed as input to the mask 511 after the first iteration is the average of the inverse Fourier transforms of the totagraphically processed output waves of the current iteration.

The overall system of the first iteration 520 is shown in FIG. 5C. The input wave 521 is split and fed into one or more OSUs as described above (500a and 500b in the depicted embodiment). The outputs of the two OSUs are then inverse Fourier transformed 524 and 525 and the average wave 526 is the output of the first iteration.

The overall system for succeeding iterations 530 is shown in FIG. 5D. The system begins with the input wave 521, which in the second iteration is the output of the first iteration 520. The signal is again split to DSU 500a and DSU 500b. The outputs of the DSUs are then inverse Fourier transformed 524, 525, and the transformed signals are averaged 526. After each iteration, the output is checked to see if it has converged sufficiently 527. If the output has converged, for example if the difference between the output and the output of the previous iteration is not significant or is below a threshold, then the output of the iteration is chosen as the output of the system 530. If the output has not yet converged, it is fed back to the input of the next iteration.

### EXPERIMENTAL EXAMPLES

The invention is further described in detail by reference to the following experimental examples. These examples are provided for purposes of illustration only, and are not intended to be limiting unless otherwise specified. Thus, the invention should in no way be construed as being limited to the following examples, but rather, should be construed to encompass any and all variations which become evident as a result of the teaching provided herein.

Without further description, it is believed that one of ordinary skill in the art can, using the preceding description and the following illustrative examples, make and utilize the system and method of the present invention. The following working examples therefore, specifically point out the exemplary embodiments of the present invention, and are not to be construed as limiting in any way the remainder of the disclosure.

### Example #1—X-Ray and EUV

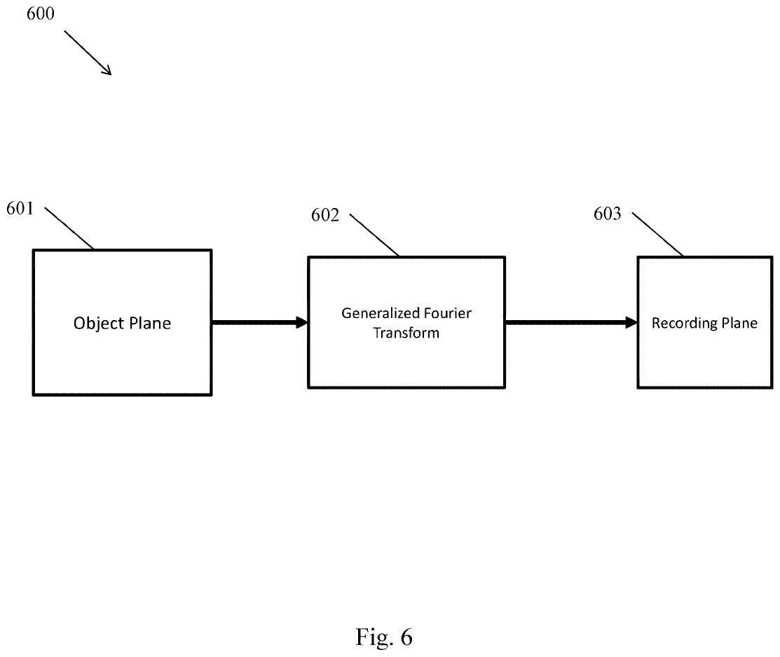

The methods discussed above were evaluated with two sets of amplitude and phase images inputted to the masks used. The lens-less imaging configuration illustrated in FIG. 6 (see C. Wagner et al, Applied Optics, 1999), and Fresnel approximation was used. Lenless imaging means no lenses were used, and coherent wave propagation provides the generalized Fourier transformation as shown in FIG. 6. A number of wavelengths at 10 nm, 7 nm, 3.4 nm and 1 nm for X-rays as well as 33.2 nm, 16m, 14 nm and 12 nm for EUV waves were experimented with. The ones reported here are 3.4 nm for X-rays, and 33.2 nm for EUV waves. Both inline plane reference wave and spherical reference wave were utilized.

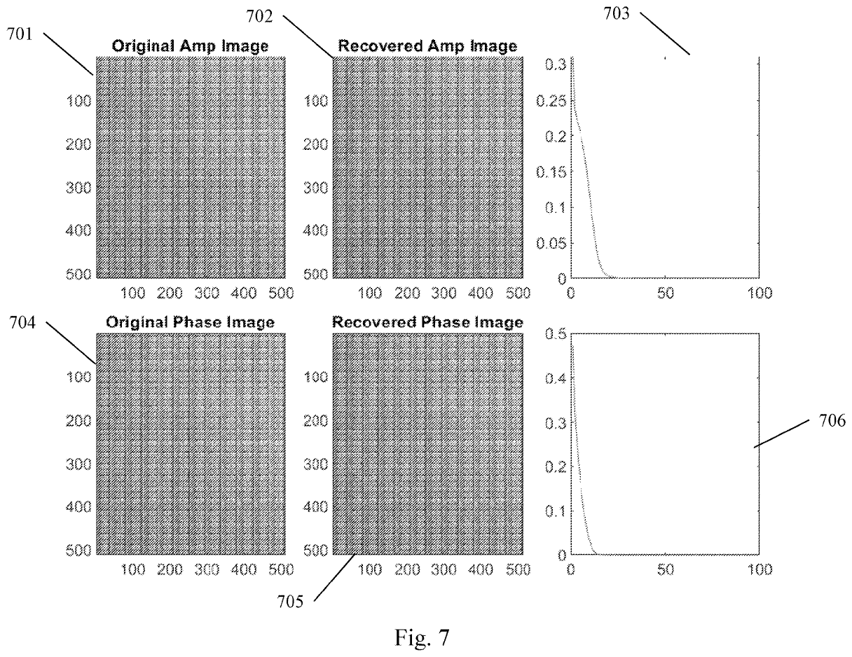

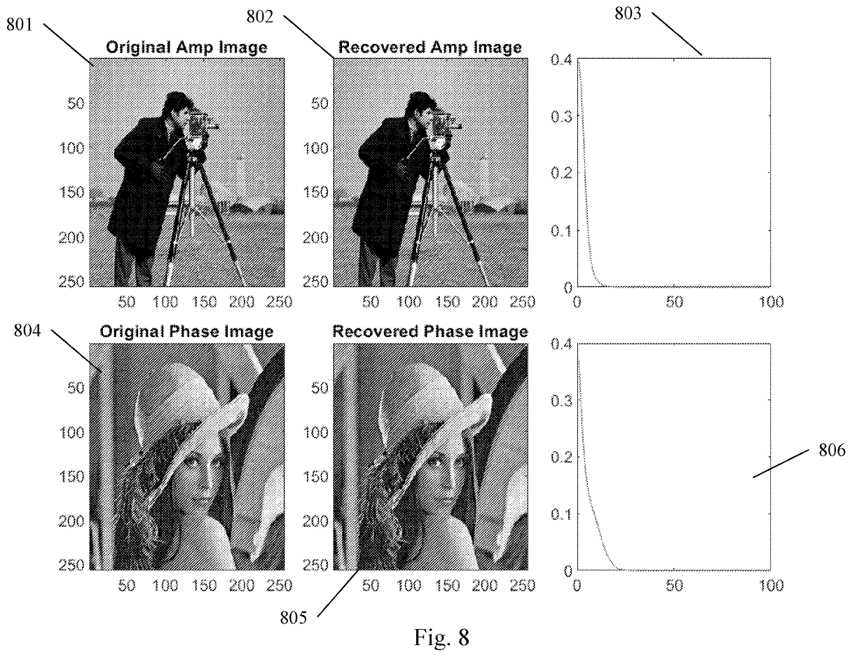

The sets of images and the information recovery results are shown in FIG. 7 and FIG. 8.

These results were the same with both wavelengths at 3.4 nm and 33.2 nm, as well as with both plane and spherical reference waves as long as reference wave amplitude is sufficiently large to avoid phase wrapping problems.

FIG. 7 shows the first set of original amplitude 701, recovered amplitude 702, original phase 704 and recovered phase 705 wafer images, and plots 703 and 706 of how squared reconstruction error approached zero with increasing iterations of the amplitude (703) and phase (706).

FIG. 8 shows the second set of original amplitude 801, recovered amplitude 802, original phase 804, and recovered phase 805 images, and plots 803 and 806 of how squared reconstruction error approached zero with increasing iterations of the amplitude (803) and phase (806).

### Example #2—Conclusion

Continuous-wave totagraphy has been further investigated, with emphasis on X-rays and EUV waves in the lensless imaging configuration. Fresnel approximation was used in digital computations. Excellent amplitude and phase recovery were achieved with two sets of amplitude and phase images at all wavelengths, as well as with both plane and spherical reference waves as long as the reference wave amplitude was sufficiently large to avoid phase wrapping problems.

### Example #3—Segmented Totagraphy

The segmented totagraphic method discussed above was applied to two sets of amplitude and phase images. The lensless imaging configuration illustrated in FIG. 6, and Fresnel approximation was used. The wavelengths used were 3.4 nm for X-rays, and 33.2 nm for EUV waves. Although the present example uses X-rays or EUV waves, it is understood that the segmented methods disclosed herein may be used with a wide variety of signals, including but not limited to visible light, IR light, radio waves, microwaves, and gamma rays.

Both inline plane reference wave and spherical reference wave were utilized. They gave very similar results as long as the reference wave amplitude was sufficiently large to avoid phase wrapping problems. So the experiments with the inline plane reference wave are discussed below.

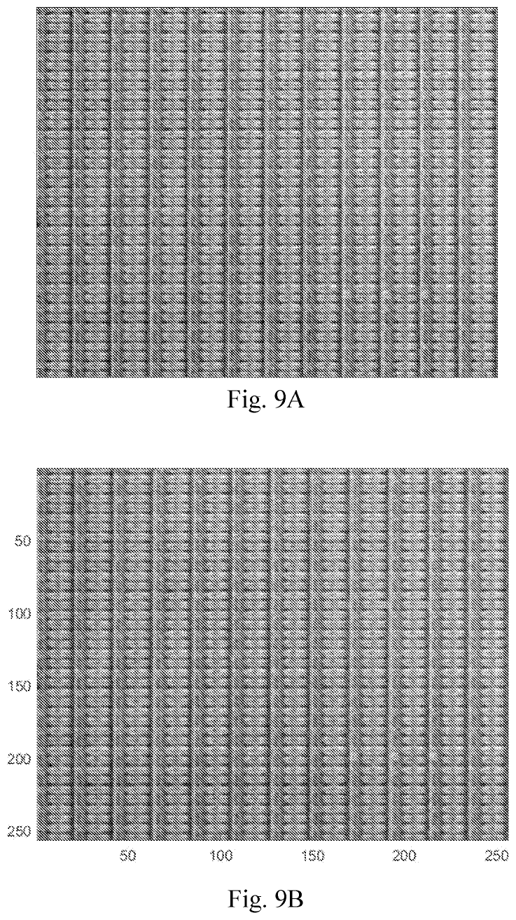

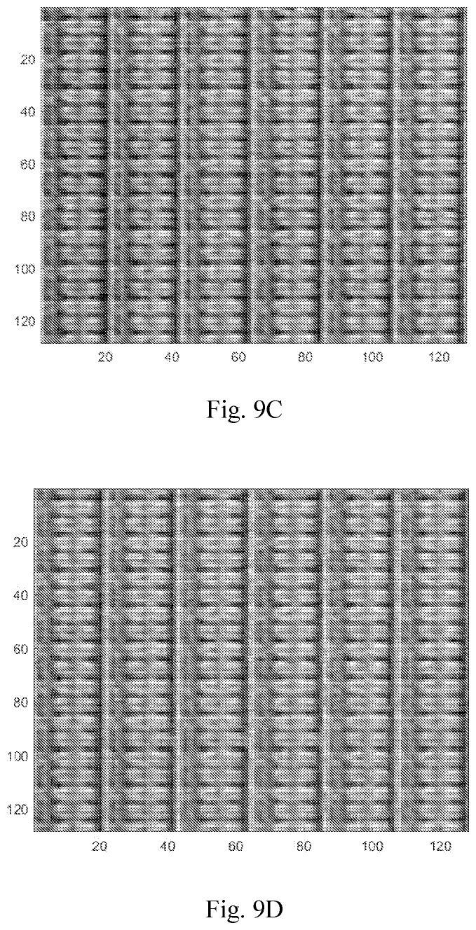

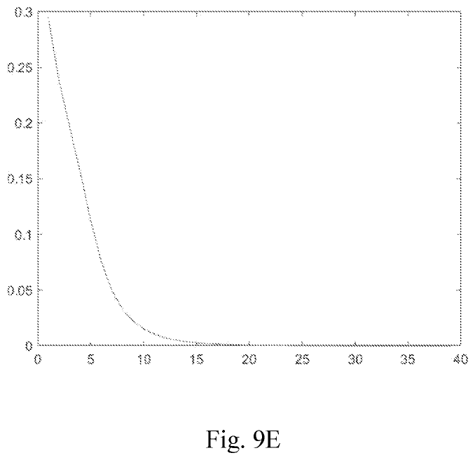

FIG. 9A shows the example image used as the original wafer amplitude. FIG. 9B shows the example image used as the wafer phase image.

FIG. 9C shows the first original amplitude patch image. FIG. 9D shows the reconstructed first original amplitude patch image. FIG. 9E shows the iterations during the reconstruction of the first amplitude patch image

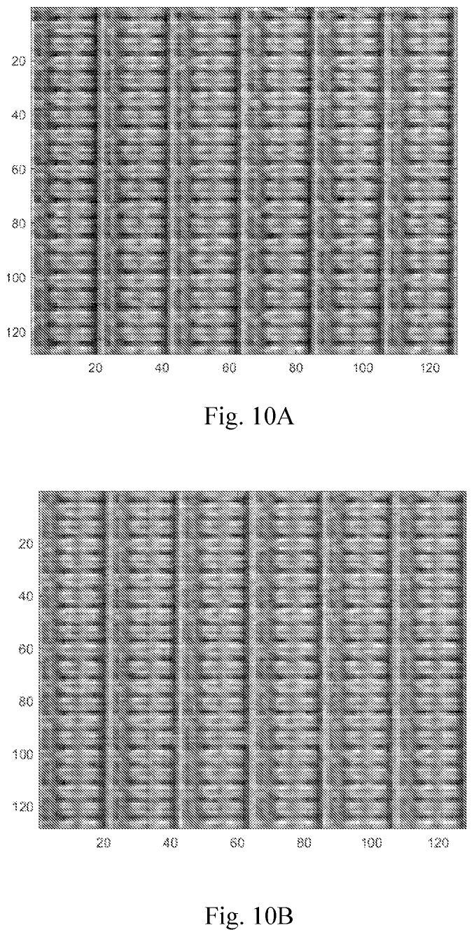

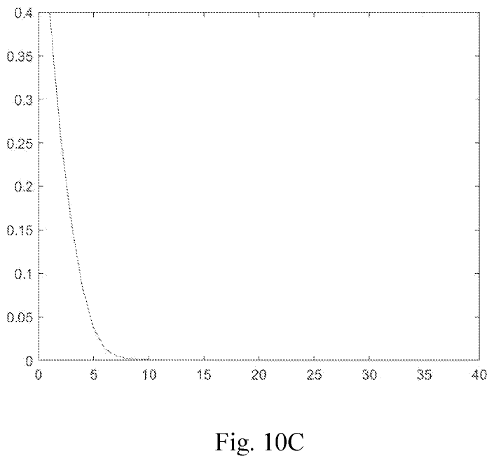

FIG. 10A shows the first original phase patch image. FIG. 10B shows the reconstructed first original phase patch image. FIG. 10C shows the iterations during the reconstruction of the first phase patch image.

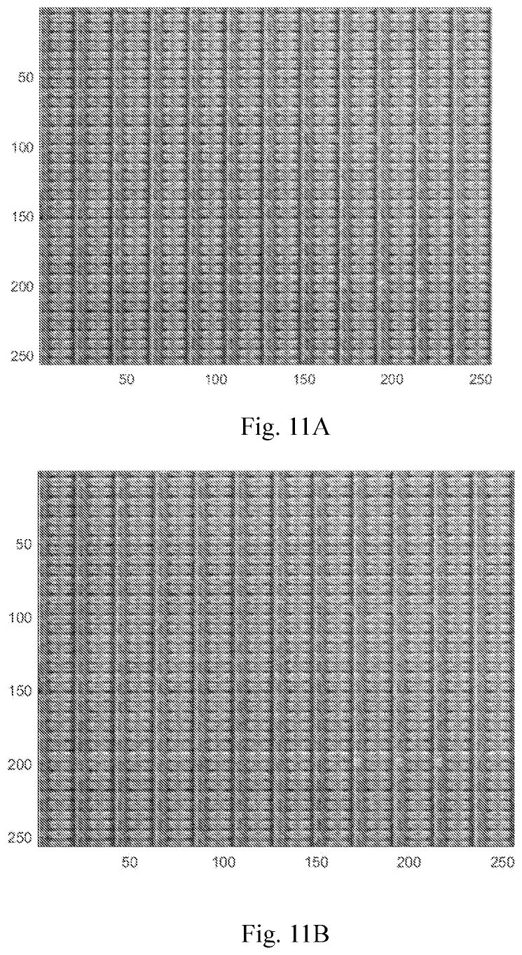

After assembling together all the reconstructed amplitude patch images, FIG. 11A is obtained. After assembling together all the reconstructed phase patch images, FIG. 11B is obtained. These figures show that the original and reconstructed amplitude and phase images are essentially the same.

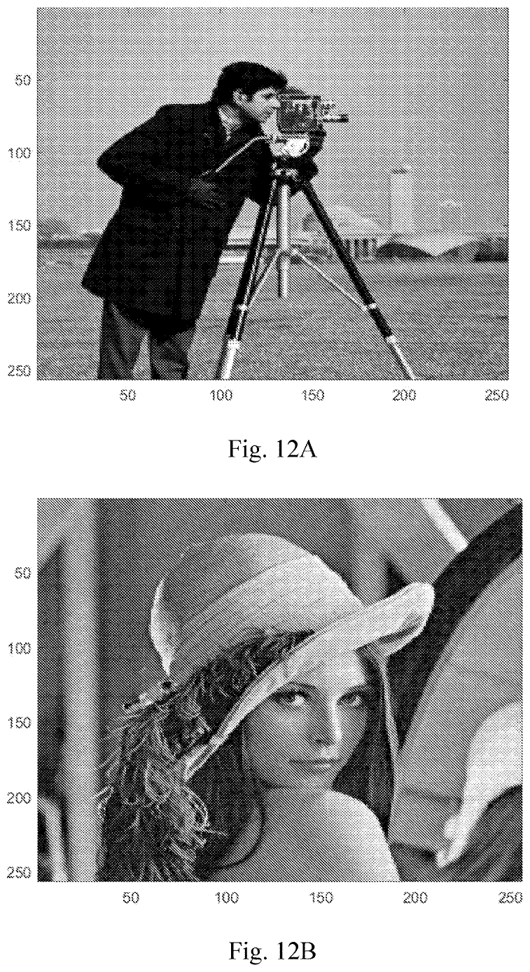

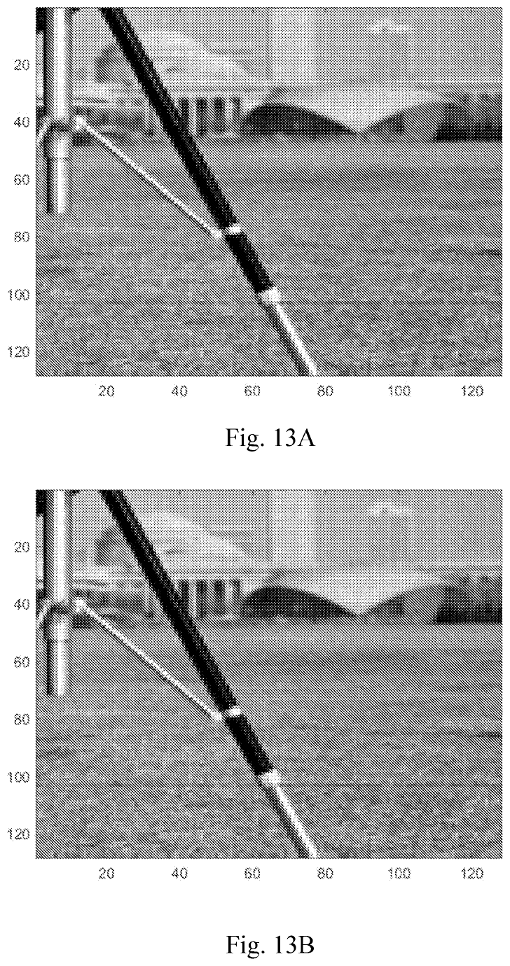

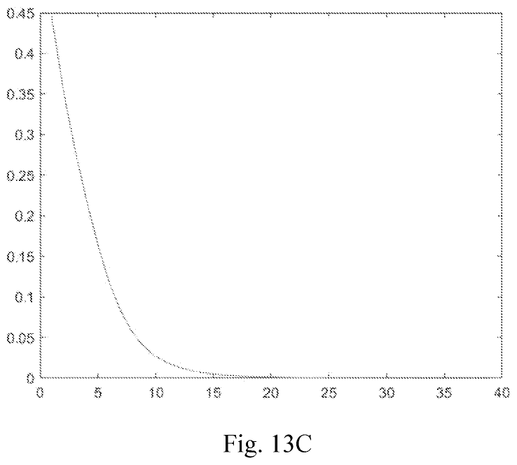

FIG. 12A shows the original cameraman amplitude image in the second set. FIG. 12B shows the original Lena phase image in the second set. FIG. 13A shows the first original amplitude patch image. FIG. 13B shows the reconstructed first original amplitude patch image. FIG. 13C shows the iterations during the reconstruction of the first amplitude patch image.

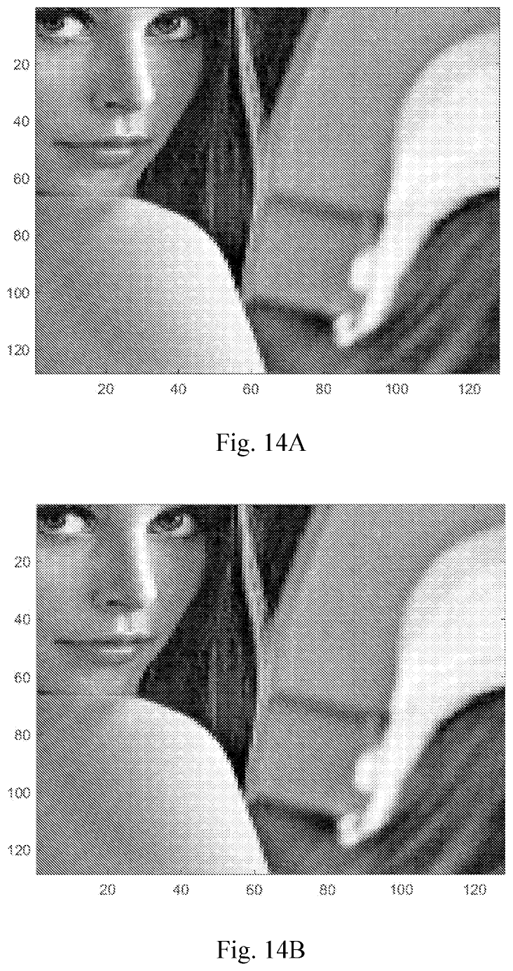

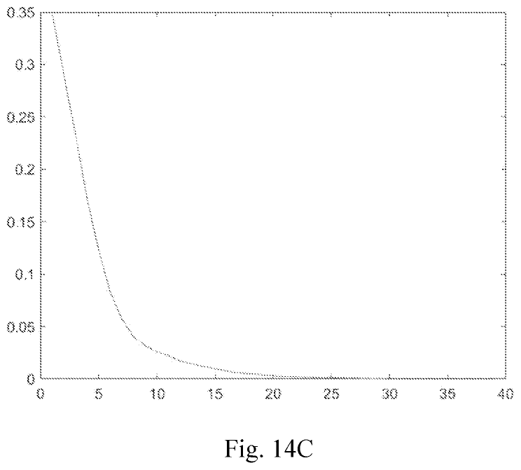

FIG. 14A shows the first original phase patch image. FIG. 14B shows the reconstructed first original phase patch image. FIG. 14C shows the iterations during the reconstruction of the first phase patch image.

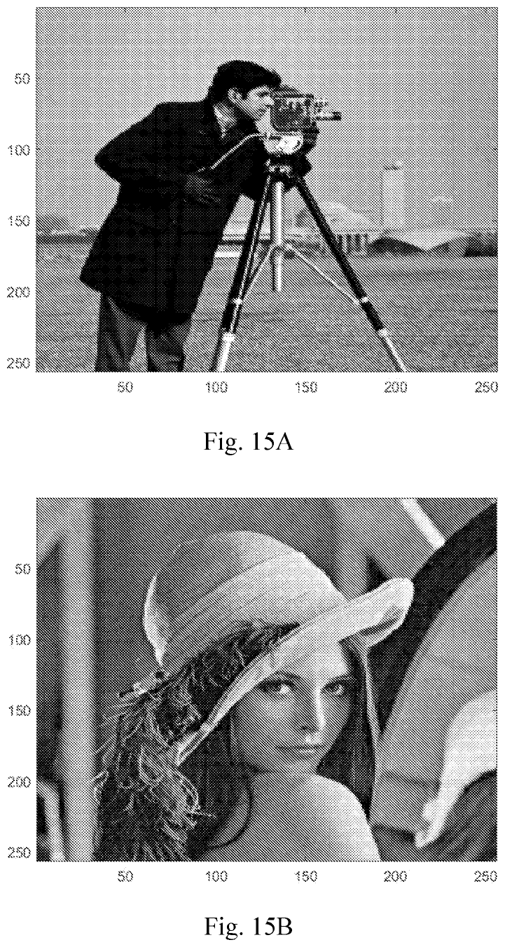

After assembling together all the reconstructed amplitude patch images, FIG. 15A is obtained. After assembling together all the reconstructed phase patch images, FIG. 15B is obtained. These figures show that the original and reconstructed amplitude and phase images are essentially the same.

### Example #4—Digital Experiments Investigating Number of Iterations, Reference Wave Amplitude and Number of Masks

The performance achievable with totagraphy heavily relies on the number of iterations, reference wave amplitude, and the number of masks used. In this section, these issues are investigated with a number of case studies at xray and EUV wavelengths as before in the order given above. The amplitude and phase images used are the cameraman and the Lena images, respectively. The reference wave used is the plane wave with zero phase, and having only constant amplitude. The size of input window doubled with the border region of zeros was chosen as 60 microns. The distance between the input plane and the spectral plane was chosen as 16 cm.

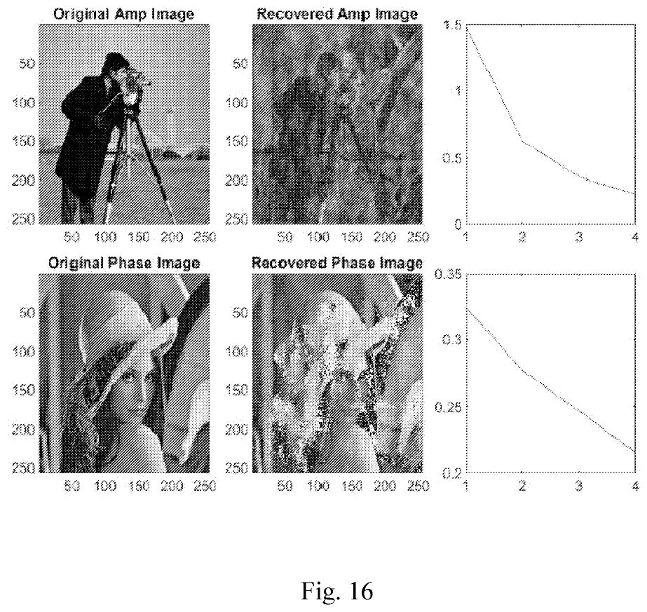

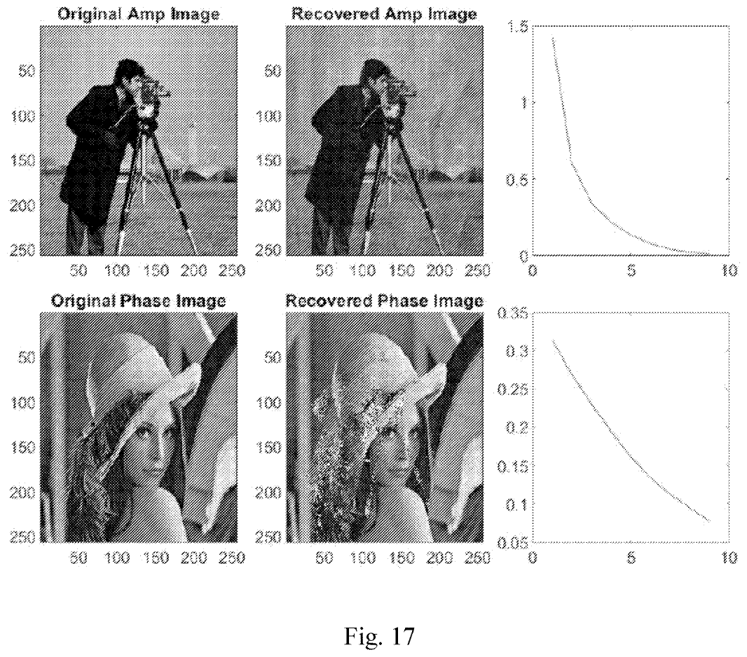

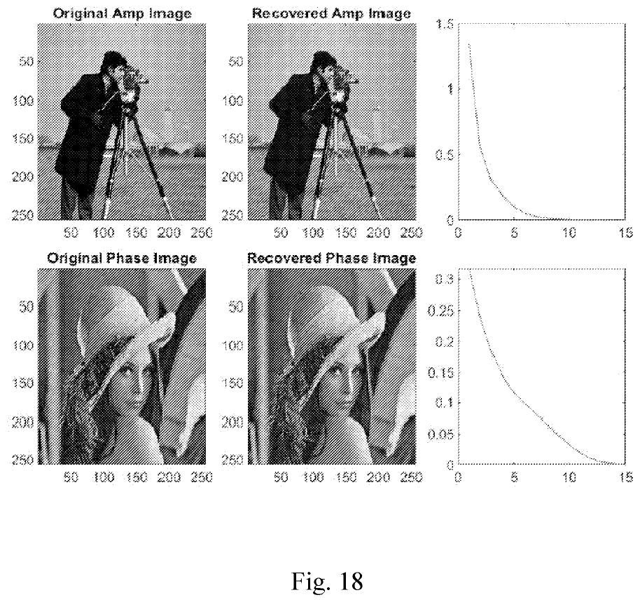

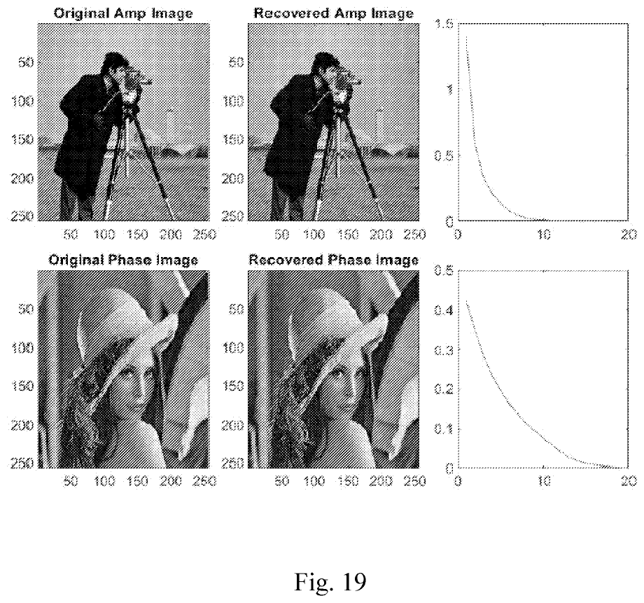

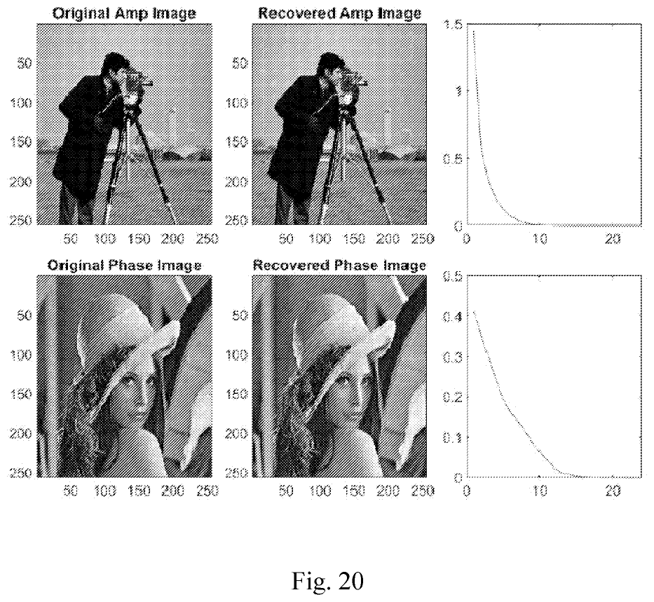

X-ray wavelength of 3.4 nm is considered first. The first set of results are obtained with one transparent mask, and two bipolar binary masks. The studies with respect to the number of iterations are illustrated in FIGS. 16 thru 20 and Table 1. FIGS. 16 thru 20 show the reconstruction quality changes as the number of iterations are increased from 5 to 25 in steps of 5 when the reference wave amplitude is 25000. With 5 iterations, the quality is really poor. It gets better as the number of iterations are increased, and it is essentially perfect with 25 iterations. Table 1 summarizes these results in tabular form in terms of mean-square amplitude and phase errors, respectively.

TABLE 1
Xray Amplitude and Phase Errors as a Function of Number of Iterations
When Two Masks are Used, and Reference Wave amplitude is 2500.

| No. of Iterations | 5 | 10 | 15 | 20 | 25 |
|---|---|---|---|---|---|
| Amplitude Error | 0.22243 | 0.010819 | 0.00029491 | 0.00013691 | 8.5501e−06 |
| Phase Error | 0.21504 | 0.056344 | 0.0021297 | 0.0025152 | 0.00011183 |

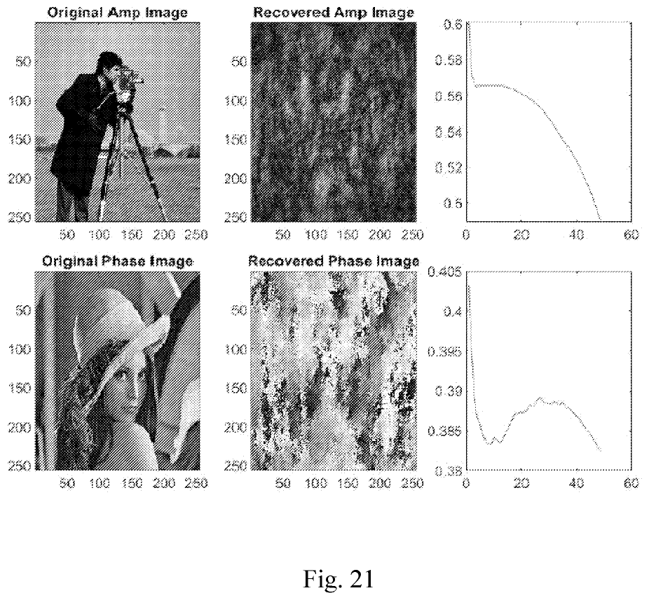

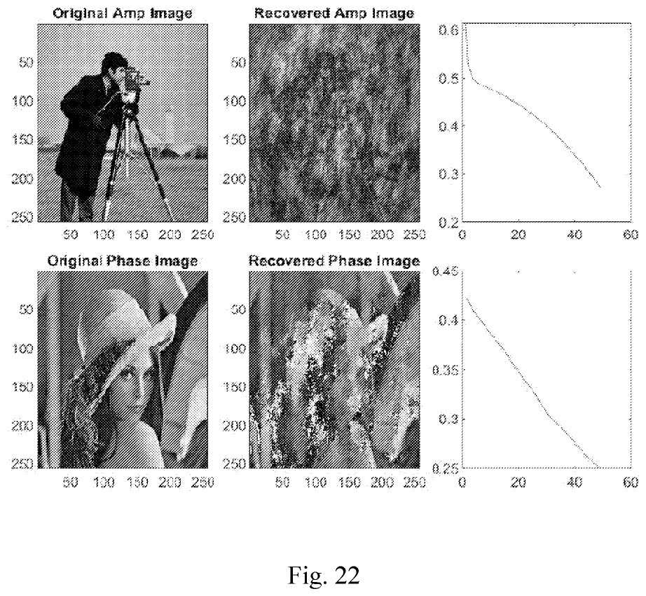

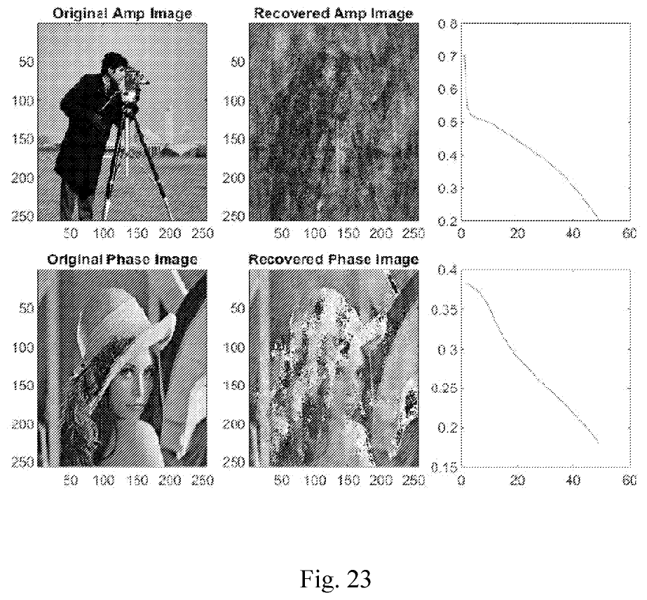

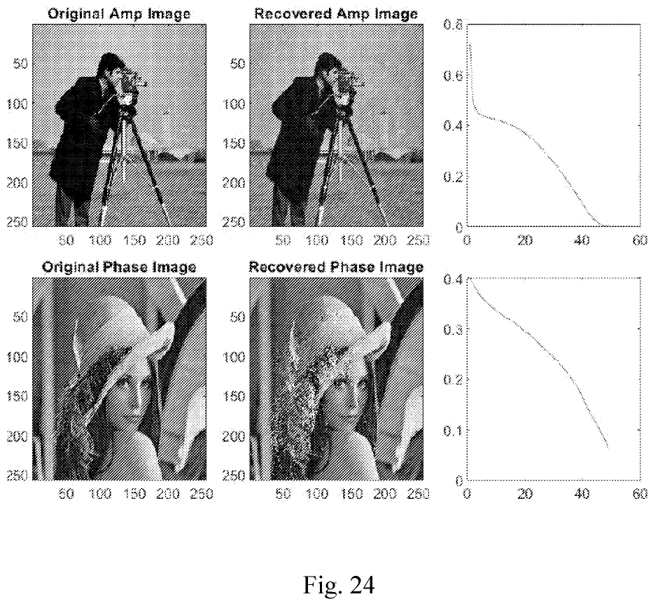

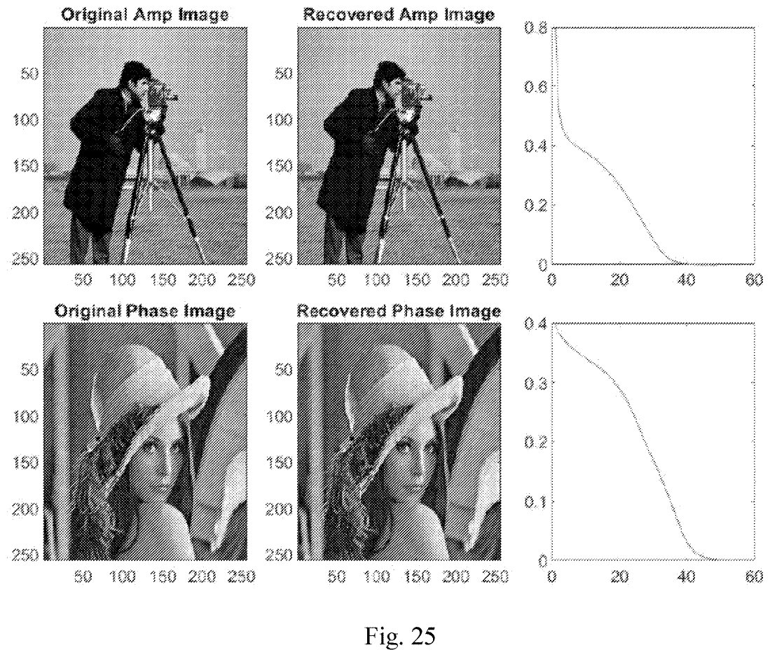

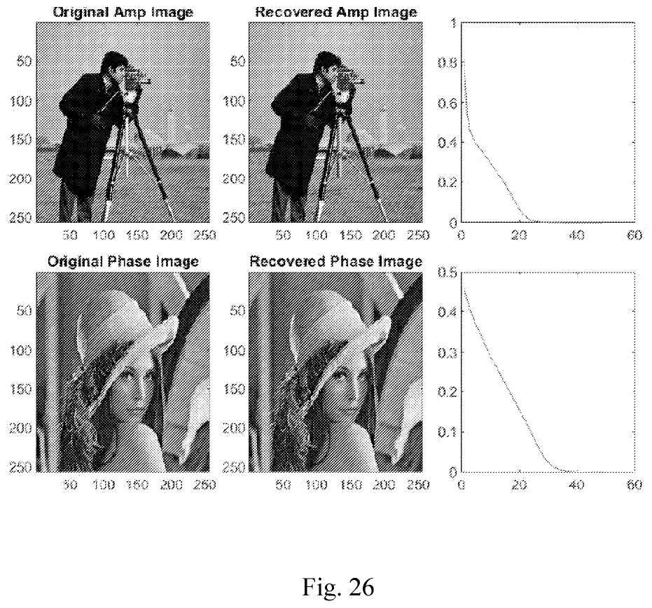

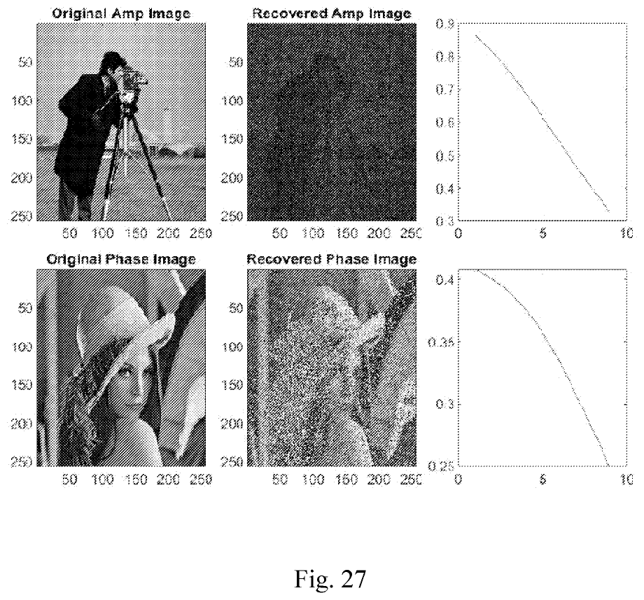

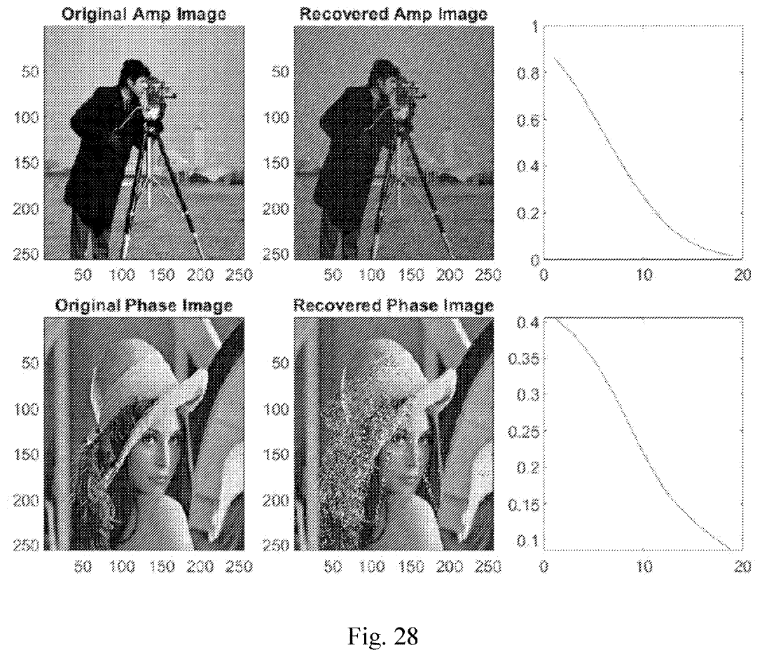

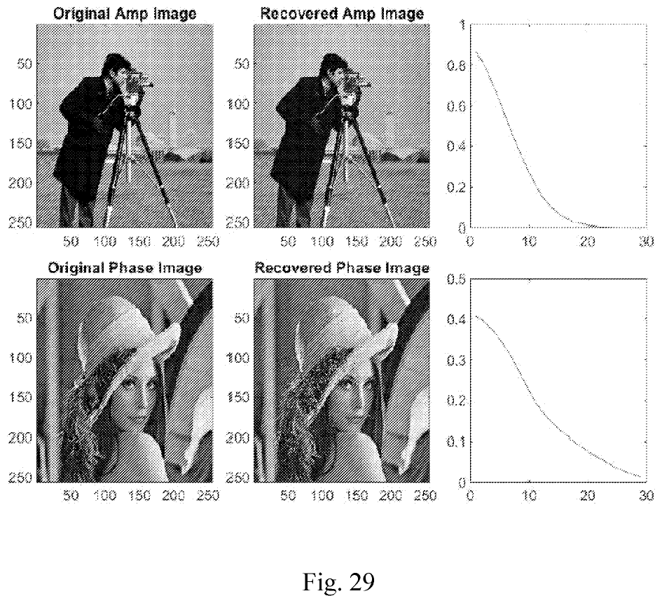

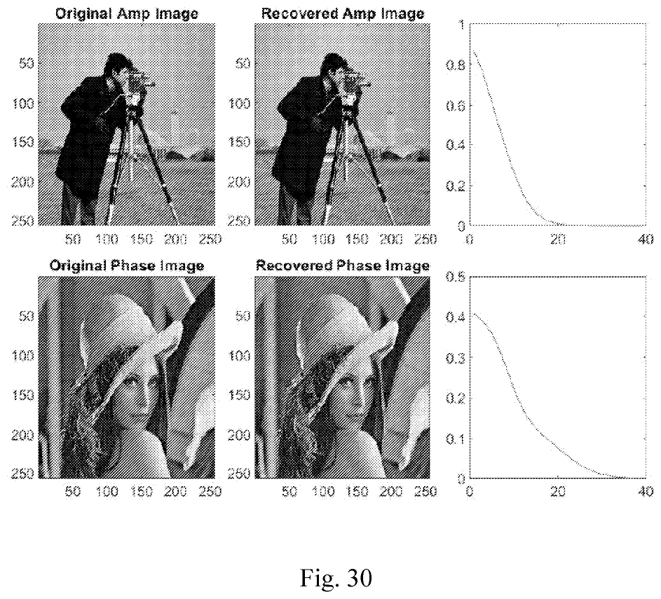

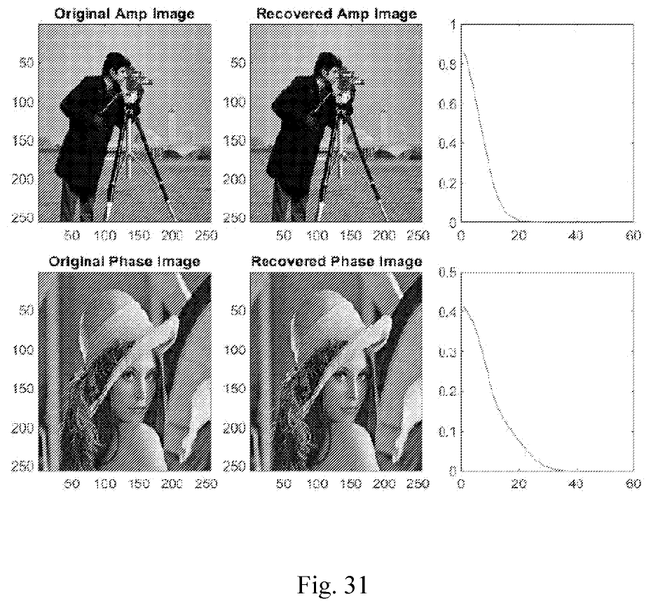

The studies with respect to the reference wave amplitude are illustrated in FIGS. 21 thru 26 and Table 2. FIGS. 21 thru 26 show the reconstruction quality changes as the reference wave amplitude is changed from 0 to 25000 in steps of 5000 while the maximum number of iterations is 50. With no reference wave, the quality is really poor, and there is no correct convergence for the reconstruction of the phase image. The quality steadily increases as the reference wave amplitude is increased, and it is essentially perfect when the reference wave amplitude is 25000. Table 2 summarizes these results in tabular form in terms of mean-square amplitude and phase errors, respectively.

TABLE 2
Xray Amplitude and Phase Errors as a Function
of Reference Wave Amplitude When Two Masks are
Used, and the Number of Iterations is 50.

| Reference | 0 | 5000 | 10000 | 15000 | 20000 |
|---|---|---|---|---|---|
| Amplitude Error | 0.48965 | 0.27185 | 0.20265 | 0.003846 | 0.0001709 |
| Phase Error | 0.38246 | 0.24902 | 0.17993 | 0.063762 | 0.0024257 |

TABLE 3
Xray Amplitude and Phase Errors as a Function of Number
of Iterations When Reference Wave amplitude is 1000000.

| No of Iterations | Amplitude Error | Phase Error |
|---|---|---|
| 5 | 0.68826 | 0.37584 |
| 10 | 0.33041 | 0.24734 |
| 15 | 0.092126 | 0.14414 |
| 20 | 0.017207 | 0.086103 |
| 25 | 0.003428 | 0.040839 |
| 30 | 0.00077977 | 0.013056 |
| 35 | 0.013056 | 0.0031409 |
| 40 | 3.71E−05 | 0.00027256 |
| 45 | 9.39E−06 | 3.50E−05 |
| 50 | 2.19E−06 | 7.82E−05 |

Next the number of masks is reduced to two, namely one transparent mask and one bipolar binary mask. In this case, there is no good enough reconstruction for both amplitude and phase images unless the reference wave amplitude is very large. In the results reported below with good reconstruction, the reference wave amplitude was chosen as 1000000.

The studies with respect to the number of iterations are illustrated in FIGS. 27 thru 31 and Table 4. FIGS. 27 thru 31 show how the reconstruction quality changes as the number of iterations are increased from 10 to 50 in steps of 10. With 10 iterations, the quality is really poor. It gets better as the number of iterations are increased, and it is essentially perfect with 50 iterations. Table 4 summarizes these results in tabular form in terms of mean-square amplitude and phase errors, respectively.

TABLE 4
EUV Amplitude and Phase Errors as a Function
of Number of Iterations When Two Masks are Used,
and Reference Wave amplitude is 1000000.

| No of Iterations | 5 | 10 | 15 | 20 | 25 |
|---|---|---|---|---|---|
| Amplitude Error | 0.32744 | 0.01122 | 0.00103 | 1.97E−05 | 1.65E−06 |
| Phase Error | 0.30353 | 0.077983 | 0.02019 | 6.41E−05 | 5.83E−06 |

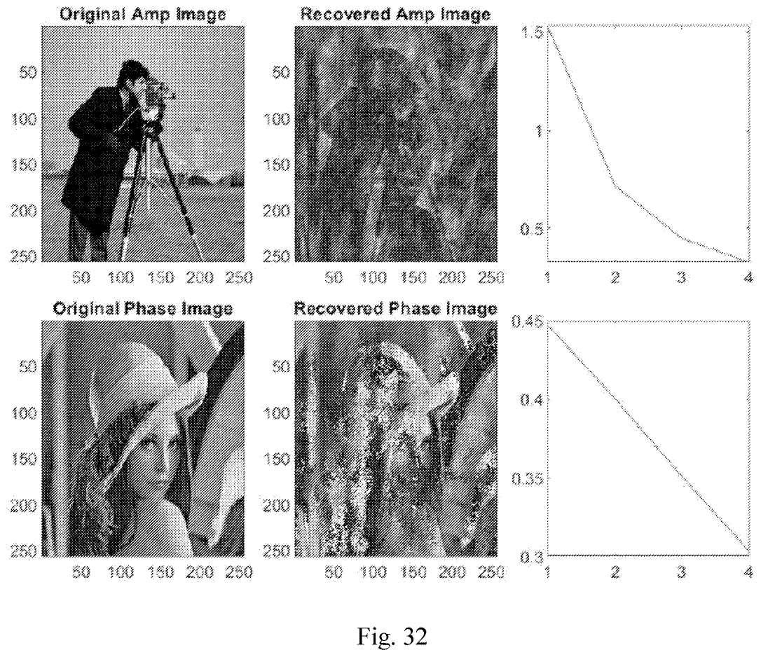

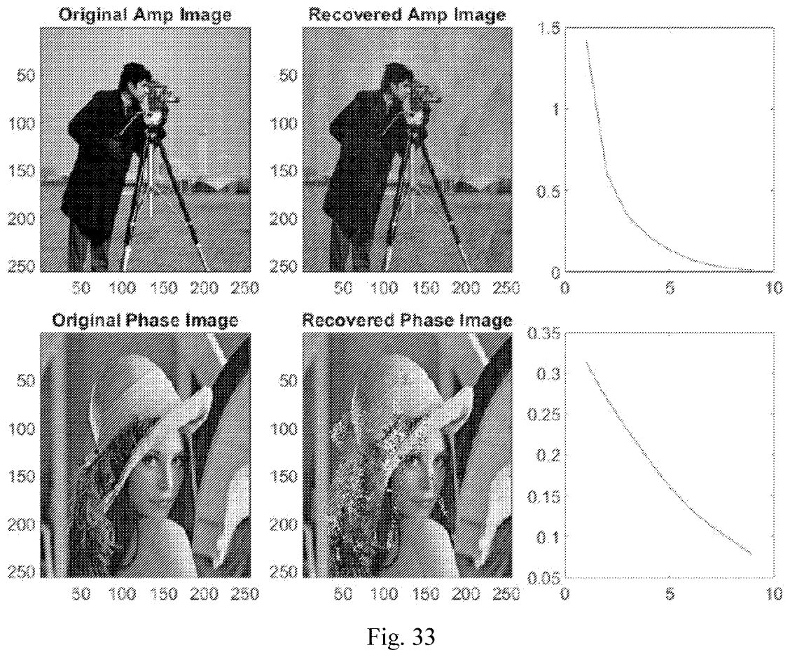

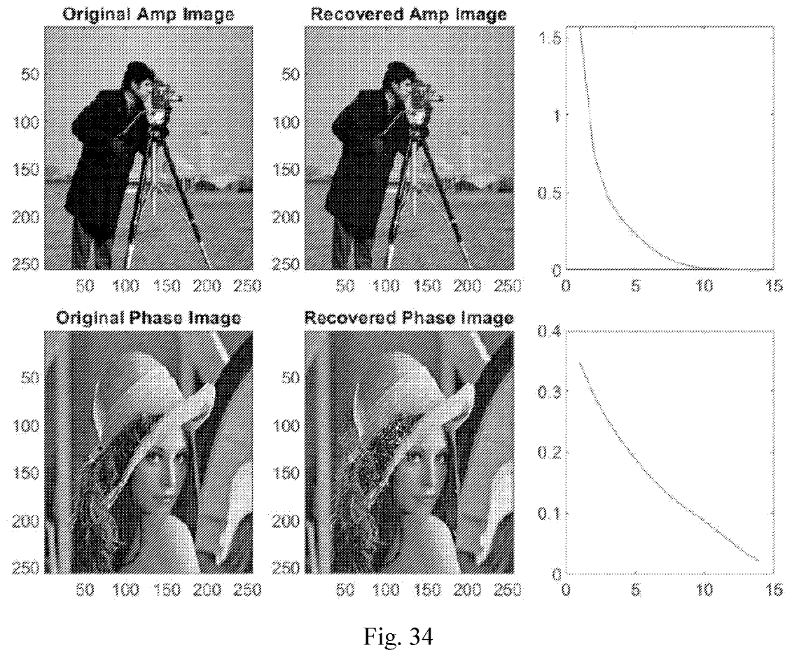

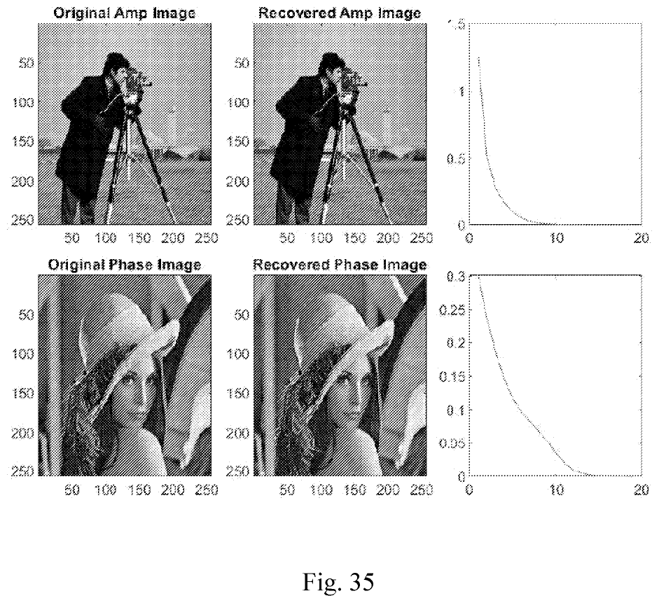

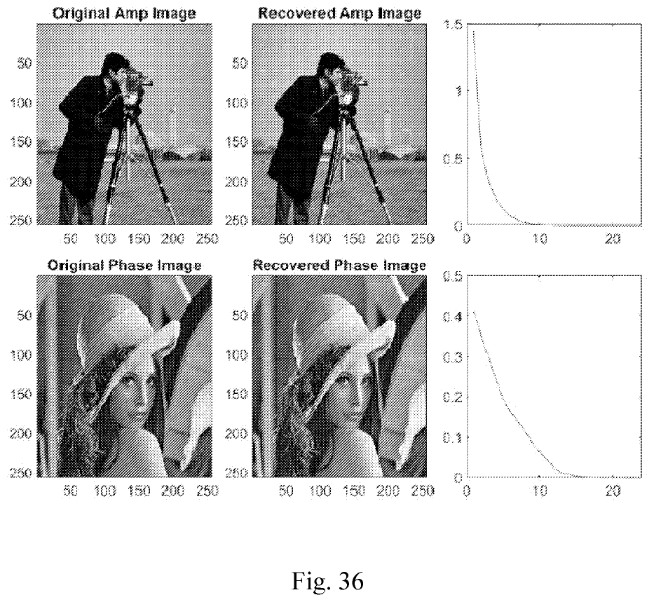

The EUV wavelength of 33.2 nm is considered first. The first set of results are obtained with one transparent mask, and two bipolar binary masks. The studies with respect to the number of iterations are illustrated in FIGS. 32 thru 36 and Table 4. FIGS. 32 thru 36 show the reconstruction quality changes as the number of iterations are increased from 5 to 25 in steps of 5 when the reference wave amplitude is 25000. With 5 iterations, the quality is really poor. It gets better as the number of iterations are increased, and it is essentially perfect with 25 iterations. Table 4 summarizes these results in tabular form in terms of mean-square amplitude and phase errors, respectively.

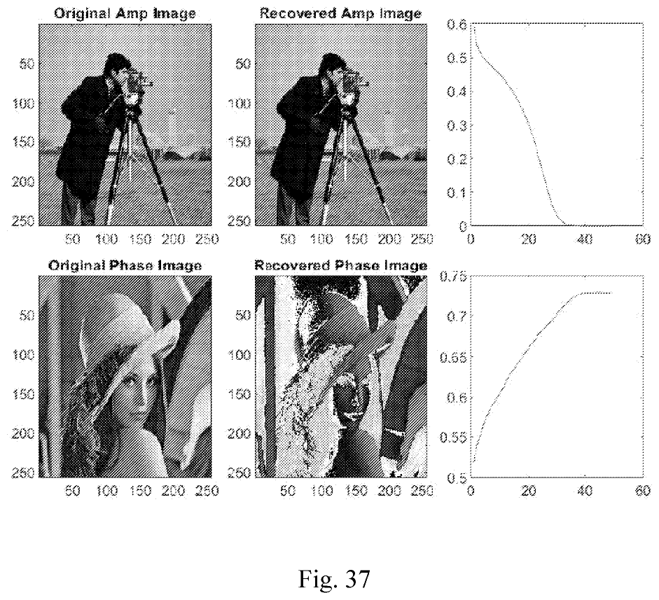

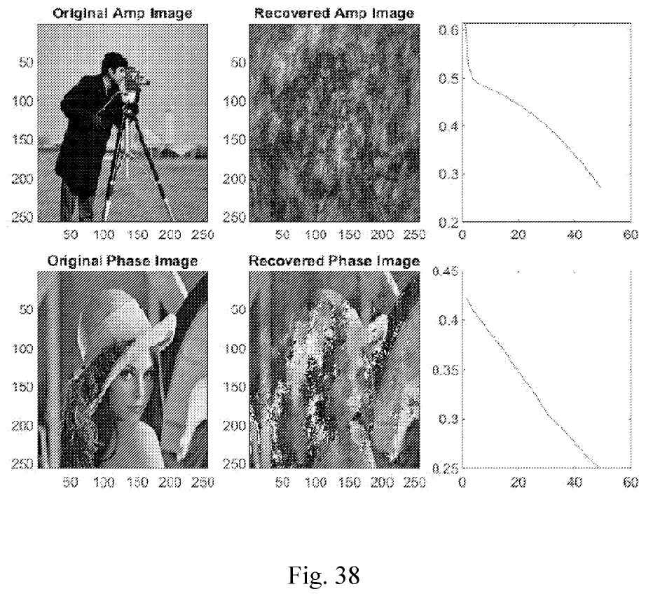

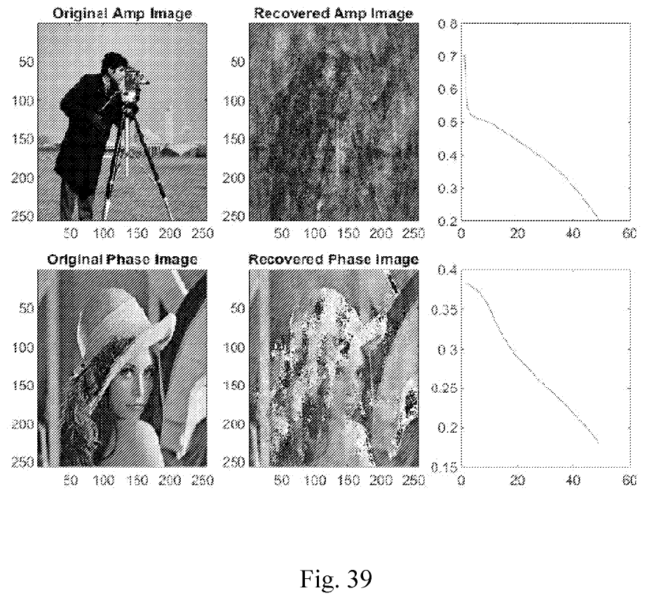

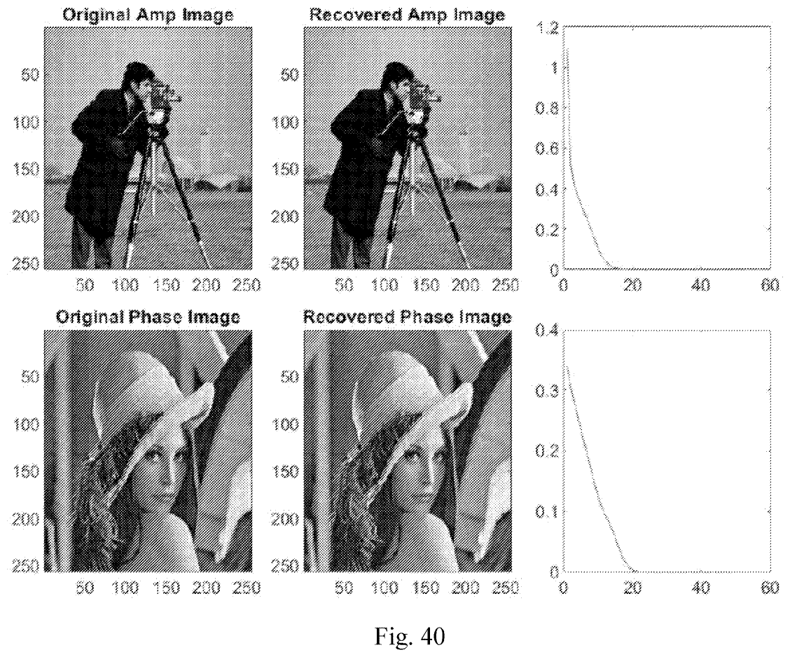

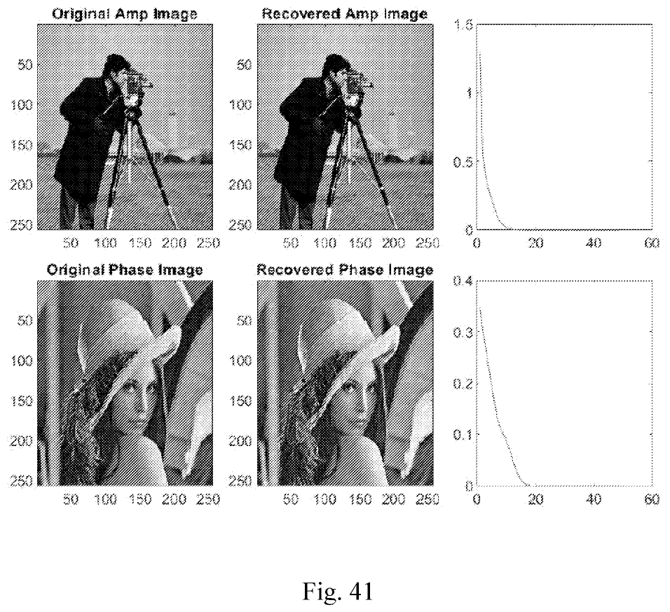

The studies with respect to the reference wave amplitude are illustrated in FIGS. 37 thru 42 and Table 5. FIGS. 37 thru 41 show the reconstruction quality changes as the reference wave amplitude is changed from 0 to 25000 in steps of 5000 while the maximum number of iterations is 50. With no reference wave, the quality is really poor, and there is no correct convergence for the reconstruction of the phase image. The quality steadily increases as the reference wave amplitude is increased, and it is essentially perfect when the reference wave amplitude is 25000. Table 5 summarizes these results in tabular form in terms of mean-square amplitude and phase errors, respectively.

TABLE 5
Amplitude and Phase Errors as a Function of Reference Wave Amplitude
When Two Masks are Used, and the Number of Iterations is 50.

| Reference | 0 | 5000 | 10000 | 15000 | 20000 |
|---|---|---|---|---|---|
| Amplitude Error | 4.1873e−06 | 0.00090196 | 0.052127 | 1.356e−06 | 3.7904e−08 |
| Phase Error | 0.72809 | 0.040166 | 0.11032 | 8.2441e−05 | 7.1115e−05 |

Next the number of masks is reduced to two, namely one transparent mask and one bipolar binary mask. In this case, there is no good enough reconstruction for both amplitude and phase images unless the reference wave amplitude is very large. In the results reported below with good reconstruction, the reference wave amplitude was chosen as 1000000.

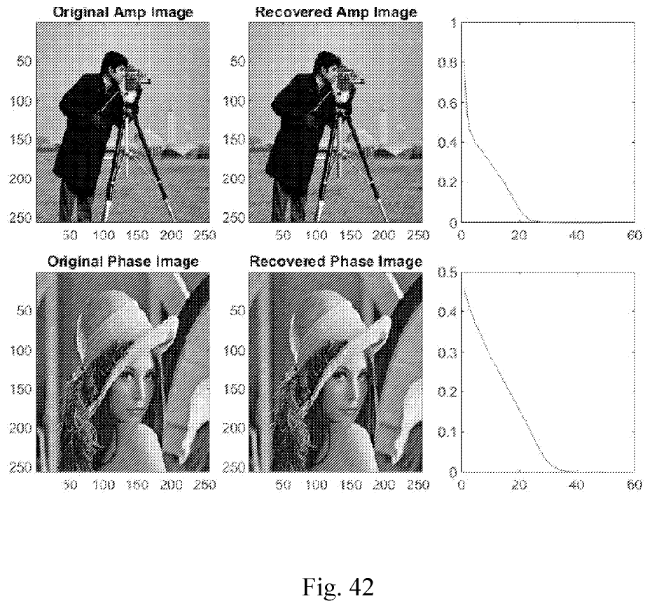

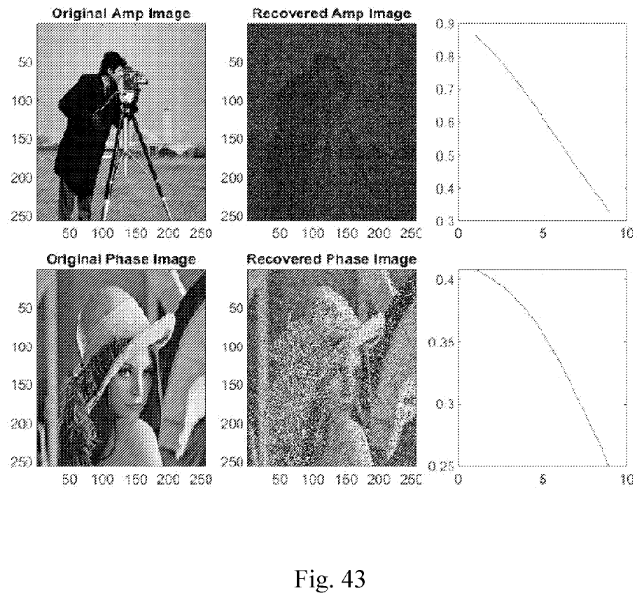

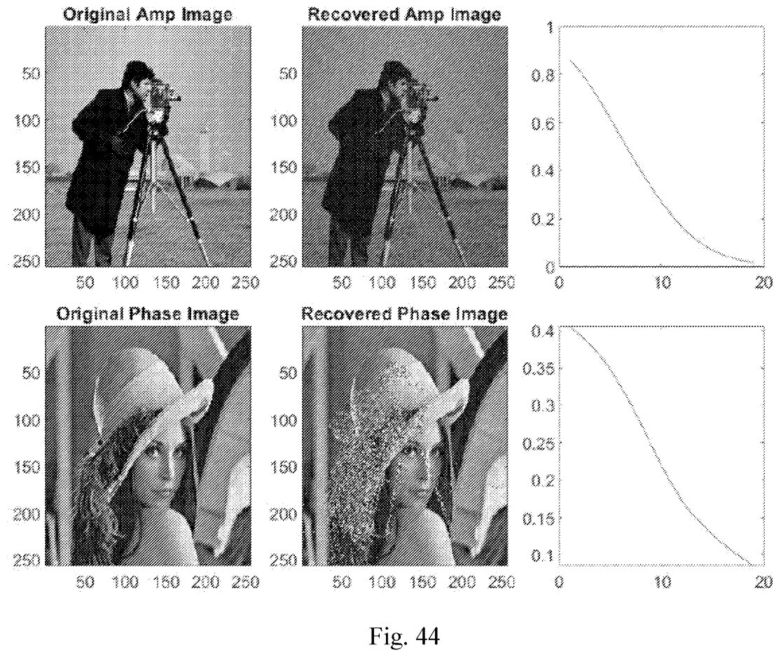

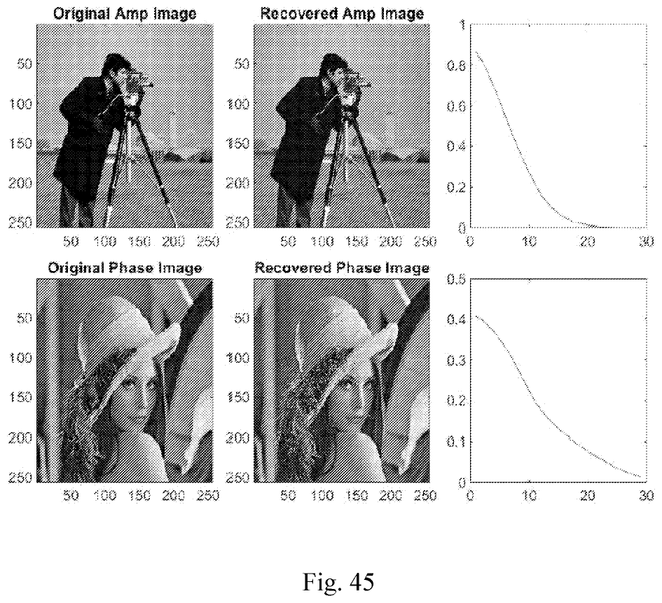

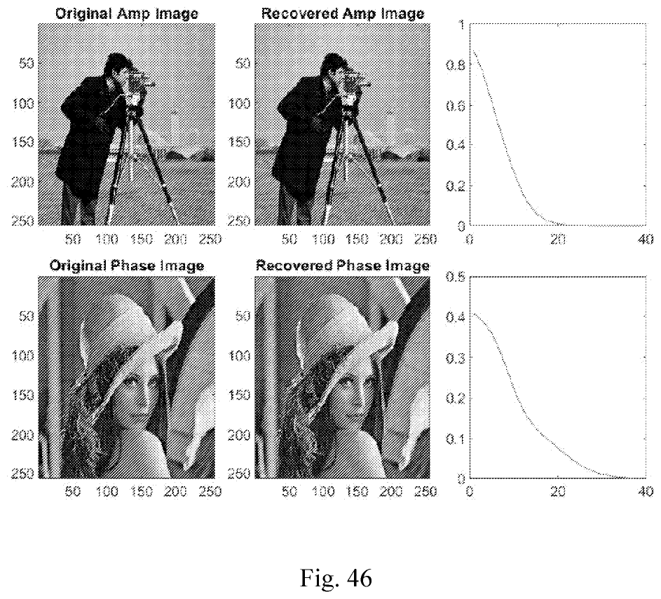

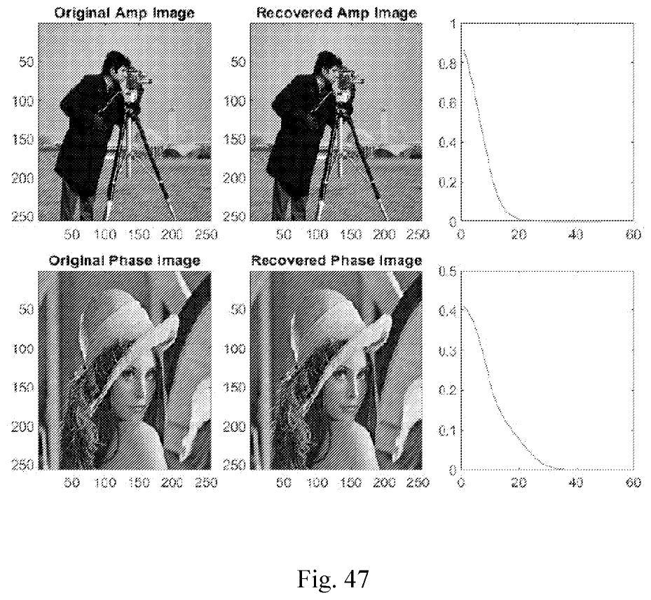

The studies with respect to the number of iterations are illustrated in FIGS. 42 thru 47 and Table 6. FIGS. 42 thru 47 show how the reconstruction quality changes as the number of iterations are increased from 10 to 50 in steps of 10. With 10 iterations, the quality is really poor. It gets better as the number of iterations are increased, and it is essentially perfect with 50 iterations. Table 6 summarizes these results in tabular form in terms of mean-square amplitude and phase errors, respectively.

TABLE 6
Amplitude and Phase Errors as a Function of Number of
Iterations When Reference Wave amplitude is 1000000.

| No of Iterations | Amplitude Error | Phase Error |
|---|---|---|
| 5 | 0.68826 | 0.37584 |
| 10 | 0.33041 | 0.24734 |
| 15 | 0.092126 | 0.14414 |
| 20 | 0.017207 | 0.086103 |
| 25 | 0.003428 | 0.040839 |
| 30 | 0.00077977 | 0.013056 |
| 35 | 0.013056 | 0.0031409 |
| 40 | 3.7083e−05 | 0.00027256 |
| 45 | 9.3901e−06 | 3.4958e−05 |
| 50 | 2.1913e−06 | 7.8212e−05 |

Segmented totagraphy has been introduced, with emphasis on X-rays and EUV waves in the lensless imaging configuration. Fresnel approximation was used in digital computations.

In quite a lot of applications, the object area or volume to be studied can be very large. For example, in semiconductor chip inspection, the wafer surface area typically has dimension of the order of 300 mm. This would be prohibitive in terms of experimentation and computations when using X-ray and EUV waves. In order to ease this problem, the area of interest is segmented in to a number of patches, and each patch is processed by totagraphy independently of the other patches.

Excellent amplitude and phase recovery were achieved with two sets of amplitude and phase images at Xray and EUV wavelengths used with one transparent and two bipolar binary masks used, as well as with both plane and spherical reference waves as long as the reference wave amplitude was sufficiently large such as 25000 to avoid phase wrapping problems. When the number of masks is reduced to one transparent mask and one bipolar binary mask, it was possible to achieve excellent results if the reference wave amplitude is very large such as 1000000.

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

### REFERENCES

The following publications are incorporated herein by reference in their entirety:
R. W. Gerchberg, “A New Approach to Phase Retrieval of a Wave Front,” Journal of Modern Optics, 49:7, 1185-1196, 2002.
Ulf Schnars et al, Digital holography and wavefront sensing, 2^{nd} edition, Springer-Verlag, Berlin, 2015.
T-C Poon, J-P Liu, Introduction to modern digital holography with Matlab, Cambridge University Press, Cambridge, 2015.
Yamaguchi, and T. Zhang, ‘Phase-shifting digital holography,’ Optics Letters 22, pp. 1268-1270, 1997.
T. Zhang, and I. Yamaguchi, ‘Three-dimensional microscopy with phase-shifting digital holography,’ Optics Letters 23, pp. 1221-1223, 1998.
I. Yamaguchi, J.-I. Kato, S. Ohta, and J. Mizuno, ‘Image formation in phase-shifting digital holography and applications to microscopy,’ Applied Optics 40, pp. 6177-6186, 2001.
S. Na and S. Shin, ‘Digital Holographic Microscopy Using a Spherical Reference Wave and Polarization Hologram,’ Journal of the Korean Physical Society, Vol. 77, No. 10, November 2020, pp. 908-911.
C. Wagner et al, ‘Digital recording and numerical reconstruction of lensless Fourier holograms in optical metrology,’ Applied Optics, Vol. 38, No. 22, pp. 4812-4820, 1 Aug. 1999.
M. J. Gieslak, et al, Coded aperture imaging systems: past, present and future development: a review,’ Radiation Measurements, 92, pp. 59-71, 2016.
D. S. Kittle, D, L, Marks, D. J. Brady, ‘Design and fabrication of an ultraviolet-visible coded aperture snapshot spectral imager,’ Optical Engineering, 51 (7), 071403, July 2012.
C. Romeo, P. Cantù, ‘Lithography Masks and Pattern Transfer,’ Science Direct, 2005.
F. Buttner, ‘Dynamic imaging with x-ray holography,’ Holographic materials and optical systems, open access, March 2016.
T. Salditt, A-L Robisch, Coherent x-ray imaging,’ Nanoscale Photonic Imaging, Topics in Applied Physics, vol 134. Springer, Cham. pp. 35-70, 2020.
M. Zurch et al, ‘Real-time and subwavelength ultrafast coherent diffraction imaging in the extreme ultraviolet,’ Scientific Reports, Open Access, December 2014.

What is claimed is:

1. A method of inspecting a wafer, comprising:
exposing a first portion of a wafer to a radiative source to produce an input signal;
passing the input signal through at least a first mask to collect a first masked input;
passing the input signal through at least a second mask to collect a second masked input;
measuring the amplitudes for the Fourier transforms of the masked inputs via a sensor configured to detect emissions of the radiative source;
assigning a set of random phase values to the amplitudes of the Fourier transforms of the masked inputs to produce a set of measured inputs;
calculating the inverse Fourier transform of the measured inputs;
averaging the inverse Fourier transformed inputs to produce a candidate output;
determining whether the candidate output has converged;
repeating the method beginning with the passing step comprising passing through at least a first and second masks, providing the candidate output as the input signal, until the candidate output converges; and
providing the candidate output as an output of the system.

2. The method of claim 1, further comprising the steps of:
moving at least one of the sensor, the radiative source, and the mask relative to the wafer and repeating the method for a second portion of the wafer different from the first portion of the wafer while the other portions are made electronically inactive, to generate a set of converged partial candidate outputs;
combining the set of converged partial candidate outputs to form a unified candidate output; and
providing the unified candidate output as the output of the system.

3. The method of claim 1, further comprising the steps of:
using an array of sensors, an array of masks, and illuminating one portion of the wafer at each time with corresponding mask and sensor, and repeating the method for a second portion of the wafer different from the first portion of the wafer while the other portions are made electronically inactive, and continuing this process with all the portions;
combining the converged candidate outputs of all the portions of the wafer to form a unified candidate output; and
providing the unified candidate output as an output of the system.

4. The method of claim 1, wherein the first mask is a transparent mask, and the second mask comprises a pair of complimentary unipolar binary masks.

5. The method of claim 1, wherein each of the at least first and second masks comprise an outer border having a thickness.

6. The method of claim 1, wherein the masks are physical spatial masks and further comprising the step of switching from one of the physical spatial masks to another of the physical spatial masks.

7. The method of claim 1, wherein the step of passing the input signal through the at least first and second masks comprises the step of splitting the input signal so that it is individually received in parallel by the at least first and second masks.

8. The method of claim 1, wherein the radiative source is selected from X-Rays or ultraviolet (UV) light.

9. A method of recovering phase information from an input signal, comprising:
exposing a measurement surface to a coherent radiative source, the radiative source selected from ultraviolet (UV) light or X-Rays to produce an input signal;
passing the input signal through at least first and second masks to collect first and second masked inputs, wherein the first mask is a transparent mask;
measuring the amplitudes of the Fourier transforms of the masked inputs via a sensor configured to detect emissions of the radiative source;
assigning a set of random phase values to the amplitudes of the Fourier transforms of the masked inputs to produce a set of measured inputs;
calculating the inverse Fourier transforms of the measured inputs;
averaging the inverse Fourier transformed inputs to produce a candidate output;
determining whether the candidate output has converged;
repeating the method digitally, beginning with the passing step comprising passing through at least first and second masks, providing the candidate output as the input signal, until the candidate output converges; and
providing the converged candidate output as an output of the system.

10. The method of claim 9, wherein the first mask is a transparent mask, and the second mask comprises a pair of complimentary unipolar binary masks.

11. The method of claim 9, wherein each of the at least first and second masks comprise an outer border having a thickness.

12. The method of claim 9, wherein the masks are physical spatial masks and further comprising the step of switching from one of the physical spatial masks to another of the physical spatial masks.

13. The method of claim 9, wherein the step of passing the input signal through the at least first and second masks comprises the step of splitting the input signal so that it is individually received in parallel by the at least first and second masks.
